(19) United States
(12) Patent Application Publication
(10) Pub. No.: US 2012/0021914 A1
(43) Pub. Date: Jan. 26, 2012

(54) Cyclodextrin-containing suspension concentrates, method for producing the same and their use

(75) Inventors: Rainer Berghaus, Speyer (DE); Matthias Bratz, Maxdorf (DE); Rainer Dyllick-Brenzinger, Neustadt (DE)

(73) Assignee: BASF SE, Ludwigshafen (DE)

(21) Appl. No.: 12/988,566

(22) PCT Filed: Apr. 23, 2009
(86) PCT No.: PCT/EP2009/054899

§ 371 Date: Oct. 19, 2010

(30) Foreign Application Priority Data
Apr. 24, 2008 (EP) 08155134.3

(51) Int. Cl. A01N 25/30; A01P 7/04; A01P 13/02; A01P 3/00

(52) U.S. Cl. 504/358; 514/777

(57) ABSTRACT

The invention relates to suspension concentrates of a plant protective agent which comprise alcohol alkoxylate and cyclodextrin. The invention also relates to a method for producing said suspension concentrates and to the use of the suspension concentrates for treating plants and their habitat, and to corresponding methods and spray mixtures containing said suspension concentrate.

The invention relates to suspension concentrates having cyclodextrin, to processes for their preparation and to the use of the suspension concentrates in the treatment of plants and their habitat as well as to corresponding processes, and also spray mixtures, comprising such a suspension concentrate.

Plant protection compositions can, in addition to the substance or substances having an immediate effect on the pests (subsequently described as plant protection active agent), comprise various types of accompanying and auxiliary substances which in various ways can strengthen the desired effect, simplify the handling, increase the shelf life or otherwise improve the properties of the product (in the literature then generally known as “additives”, “adjuvants”, “accelerators”, “boosters” or “enhancers”).

Typically, plant protection compositions are dissolved, emulsified or dispersed in aqueous medium in order to obtain an aqueous spray mixture which is then applied in the “spray method” to the plants or their habitat. The accompanying and auxiliary substances must be appropriately chosen in order to produce a suitable spray mixture.

The action of the effect-promoting adjuvants is generally based on their surface activity with regard to the hydrophobic plant surface, which improves the contact of the spray mixture with the plant surface. A distinction is made in detail between wetters, spreaders and penetrators, these groups naturally overlapping. Subsequently, the general term “adjuvant” is used without consideration of physical details to describe auxiliaries for enhancing the effect of agrochemical active agents, in particular plant protection active agents.

Nonionic hydrophobic alkoxylates are known as suitable adjuvants for various plant protection active agents, above all fungicides.

Such alkoxylates are above all used in liquid formulations, including solutions, emulsions, suspensions, suspoemulsions and other liquid formulation types. However, in many cases, this is beset by problems.

For example, it has been established that, with suspension concentrates, the addition of activity-enhancing amounts of alcohol alkoxylates resulted in physical instability of the formulations, which manifested itself in particular in increasing agglomeration of the active agent particles.

It was therefore the object to make available suspension concentrates which exhibit an adequate stability in spite of activity-enhancing amounts of alcohol alkoxylates.

Surprisingly, it has now been found that the addition of cyclodextrins to the suspensions counteracts the agglomeration of active agent particles. In addition, such cyclodextrin-comprising suspension concentrates are subject to weaker Ostwald ripening than suspension concentrates without cyclodextrin addition.

A subject matter of the present invention is accordingly suspension concentrates of a plant protection active agent comprising alcohol alkoxylate and cyclodextrin.

The term “suspension concentrate” is used here for compositions which exhibit finely divided solid particles of active agent as suspension (dispersion) in a fluid medium. The active agent is accordingly only sparingly soluble or virtually insoluble in the fluid medium (generally to less than 2000 ppm).

The suspension concentrates according to the invention comprise, in addition to one or more active agents, essentially two components:
(a) an alcohol alkoxylate component composed of an alcohol alkoxylate or a mixture of several alcohol alkoxylates; and
(b) a cyclodextrin component composed of one or more cyclodextrins.

Since the active agent(s) is (are) generally plant protection active agents, the suspension concentrates according to the invention are usually plant protection compositions, for which reason plant protection compositions or compositions according to the invention are also referred to subsequently.

According to a particular embodiment, the alcohol alkoxylate to be used is low-melting or liquid. The term “liquid” describes the liquid physical state at standard pressure and a temperature in the range from 20 to 30° C. A low-melting-point alcohol alkoxylate generally has a melting point of less than 40° C., in particular of less than 30° C.

According to an additional particular embodiment, the alcohol alkoxylate to be used is oily. In this connection, the term “oily” describes a viscous sticky-greasy physical consistency; chemically, the substance can be looked at as lipophilic, hydrophilic or amphiphilic. The alcohol alkoxylates are generally amphiphilic.

The alcohol alkoxylates according to the invention basically comprise a hydrophobic or lipophilic part and one or more polymeric alkoxylate parts (polyalkoxylate or macrogol parts), the alkoxylate part or each individual alkoxylate part being coupled via an ether bond, to the hydrophobic or lipophilic part. The term “polymer” means in this connection put together from at least two, in particular at least three, very particularly from 3 to 1000 low molecular weight units. These units can among one another either be all of the same kind, so that a monotonic polymer is formed, or can comprise at least two different types of alkylene oxide. In the latter case, it is preferable each time to arrange several alkylene oxide units of one type as a block, so that at least two different alkylene oxide blocks ensue as structural elements of the polymer, each of which consists of a monotonic sequence of identical alkylene oxide units (block polymer or block copolymer). If such block alkoxylates are used, it is preferable for the alkylene oxide part to be composed of 2 or 3 and in particular of 2 blocks. If the alkoxylate part comprises different blocks, those lying closer to the hydrophobic or lipophilic part are described as “proximal”, those lying further away are described as “distal” and those positioned at the end are described as “terminal”. Mention may in particular be made here, as alkoxylate monomers according to the invention, of alkylene oxides with from 2 to 16 carbon atoms, in particular ethylene oxide (EO), propylene oxide (PO), butylene oxide (BO), pentylene oxide (PeO), hexylene oxide (HO) and decylene oxide (DeO).

Particular alcohol alkoxylates are found among alkoxylated fatty alcohols, alkoxylated alkylphenols and alkoxylated di- and tristyrylphenols, the alkylphenols preferably being polyalkylated, in particular dialkylated or trialkylated. Furthermore, the alcohol alkoxylates can also be end-group-modified, i.e. the terminal OH group of the alkoxylate part is modified, for example etherified or esterified. Suitable end-group-modified alcohol alkoxylates include in particular alkylated, alkenylated or arylated alcohol alkoxylates, preferably those with a methyl or tert-butyl group or a phenyl group, or polyalkoxylate esters, e.g. mono- or diphosphate esters or sulfate esters, and their salts, for example the alkali metal or alkaline earth metal salts. Such an end-group modification can, for example, be carried out with dialkyl sulfate, C₁₋₁₀-alkyl halide or phenyl halide.

At least some of the alcohol alkoxylates which can be used are known per se. For example, WO 03/090531, WO 2005/015998, WO 00/35278, WO 99/03345 and WO 2005/084435 describe suitable alcohol alkoxylates. Reference is expressly made herewith to the description of these alcohol alkoxylates in these documents, by which the alcohol alkoxylates themselves and also their preparation disclosed therein are part of the present disclosure.

In an additional particular embodiment, alcohol alkoxylates are chosen from alcohol alkoxylates according to the formula (I)

R¹—O—(CₘH₂ₘO)ₓ—(CₙH₂ₙO)_{y}—(CₚH₂ₚO)_{z}—R⁶ (I)

in which
R¹ is an aliphatic hydrocarbon radical with from 1 to 100 carbon atoms;
R² is hydrogen, an organic radical or an inorganic acid group;
m, n and p are, independently of one another, a whole number from 2 to 16, preferably 2, 3, 4 or 5;
x, y and z are, independently of one another, a number from 0 to 1000; and
x+y+z corresponds to a value from 2 to 1000.

The aliphatic hydrocarbon radical is generally hydrophobic or lipophilic, by which the alcohol alkoxylates obtain their oily properties. In particular, R¹ is a branched or linear hydrocarbon radical with from 1 to 30 and preferably from 5 to 24 carbon atoms which can be saturated (in particular C₁₋₃₀-alkyl) or unsaturated (in particular C₃₋₃₀-alkenyl).

The organic radical (R²) typically contributes less than 10% and preferably less than 5% to the molecular weight of the alcohol alkoxylate of the formula (I) and is preferably hydrogen, alkyl, preferably C₁₋₁₀-alkyl, particularly preferably methyl or tert-butyl, alkenyl, preferably C₂₋₁₀-alkenyl, acyl, in particular acetyl, propionyl, butyryl or benzoyl, or aryl, in particular phenyl, or is an inorganic acid group, in particular phosphate, diphosphate or sulfate.

In the formula (I), several alkylene oxide units can be arranged in any order. The structural unit —(CₘH₂ₘO)ₓ—(CₙH₂ₙO)_{y}—(CₚH₂ₚO)_{z}— can accordingly be a random copolymer, a gradient copolymer, an alternating copolymer or block copolymer of alkylene oxide blocks —(CₘH₂ₘO)ₓ—, alkylene oxide blocks —(CₙH₂ₙO)_{y}— and/or alkylene oxide blocks —(CₚH₂ₚO)_{z}—. The arrangement is preferably in blocks.

According to one aspect, it is preferable for the alcohol alkoxylates to be used according to the invention to be ethoxylated or to exhibit at least one ethylene oxide block. According to an additional aspect, ethylene oxide blocks are combined in particular with propylene oxide, butylene oxide or pentylene oxide blocks.

According to a particular embodiment, use is made of alcohol alkoxylates of the formula (I) in which m=2 and x>0. In this connection, alcohol alkoxylates of EO type are concerned, including above all alcohol ethoxylates (m=2; x>0; y, z=0) and alcohol alkoxylates with a proximal EO block (m=2; x>0; y and/or z>0).

A particular embodiment of the alcohol alkoxylates with a proximal EO block is represented by those with a distal or terminal block made from other monomers (n>2; y>0; z>0 or n>2; y>0; z=0). Mention may be made, among these, above all of EO-PO block alkoxylates (n=3; y>0; z=0). Preference is given to EO-PO block alkoxylates in which the ratio of EO to PO (x to y) is preferably from 1:1 to 4:1 and in particular from 1.5:1 to 3:1. In this connection, the degree of ethoxylation (value of x) is generally from 1 to 20, preferably from 2 to 15 and in particular from 4 to 10 and the degree of propoxylation (value of y) is generally from 1 to 20, preferably from 1 to 8 and in particular from 2 to 5. The total degree of alkoxylation, i.e. the sum of EO and PO units, is generally from 2 to 40, preferably from 3 to 25 and in particular from 5 to 15.

Mention may also be made, among the particular alcohol alkoxylates with a proximal EO block, of EO-BO block alkoxylates (n=4; y>0; z=0). Preference is given in this connection to EO-BO block alkoxylates in which the ratio of EO to BO (x to y) is preferably from 1.1:1 to 25:1 and in particular from 3:1 to 10:1. In this connection, the degree of ethoxylation (value of x) is generally from 1 to 50, preferably from 3 to 40 and in particular from 5 to 30 and the degree of butoxylation (value of y) is generally from 0.5 to 30, preferably from 1 to 20 and in particular from 1.5 to 15. The total degree of alkoxylation, i.e. the sum of EO and BO units, is generally from 2 to 70, preferably from 4.5 to 29 and in particular from 6.5 to 17.

Mention may also be made, among the particular alcohol alkoxylates with a proximal ED block, of EO-PeO block alkoxylates (n=5; y>0; z=0). Preference is given in this connection to EO-PeO block alkoxylates in which the ratio of EO to PeO (x to y) is preferably from 2:1 to 25:1 and in particular from 4:1 to 15:1. In this connection, the degree of ethoxylation (value of x) is generally from 1 to 50, preferably from 4 to 25 and in particular from 6 to 15 and the degree of pentoxylation (value of y) is generally from 0.5 to 20, preferably from 0.5 to 4 and in particular from 0.5 to 2. The total degree of alkoxylation, i.e. the sum of EO and PeO units, is generally from 1.5 to 70, preferably from 4.5 to 29 and in particular from 6.5 to 17.

According to an additional particular embodiment, use is made of alcohol alkoxylates of the formula (I) in which n=2, the values of m, x and y are each time greater than zero and z=0. In this connection, alcohol alkoxylates of EO type are also concerned in which the EO block is, though, distally bonded and an additional polyalkoxylate block is inserted between it and the aliphatic hydrocarbon radical. Mention may above all be made, among these, of PO-EO block alkoxylates (n=2; x>0; y>0; m=3; z=0). Preference is given to PO-EO block alkoxylates in which the ratio of PO to EO (x to y) is preferably from 1:10 to 3:1 and in particular from 1.5:1 to 1:6. In this connection, the degree of ethoxylation (value of y) is generally from 1 to 20, preferably from 2 to 15 and in particular from 4 to 10 and the degree of propoxylation (value of x) is generally from 0.5 to 10, preferably from 0.5 to 6 and in particular from 1 to 4. The total degree of alkoxylation, i.e. the sum of EO and PO units, is generally from 1.5 to 30, preferably from 2.5 to 21 and in particular from 5 to 14.

Mention may also be made, among the particular alcohol alkoxylates with a terminal EO block, of BO-EO block alkoxylates (n=2; y>0; m=4; x>0; z=0). Preference is given in this connection to BO-EO block alkoxylates in which the ratio of BO to EO (x to y) is from 1:1.1 to 1:25 and in particular from 1:3 to 1:10. In this connection, the degree of butoxylation (value of x) is generally from 0.5 to 30, preferably from 1 to 20 and in particular from 1.5 to 15 and the degree of ethoxylation (value of y) is generally from 1 to 50, preferably from 3 to 40 and in particular from 5 to 30. The total degree of alkoxylation, i.e. the sum of EO and BO units, is generally from 2 to 70, preferably from 4.5 to 29 and in particular from 6.5 to 17.

Mention may additionally be made, among the particular alcohol alkoxylates with a terminal EO block, of PeO-EO block alkoxylates (n=2; y>0; m=5; x>0; z=0). Preference is given in this connection to PeO-EO block alkoxylates in which the ratio of PeO to EO (x to y) is from 1:50 to 1:3 and in particular from 1:25 to 1:5. In this connection, the degree of pentoxylation (value of x) is generally from 0.5 to 20, preferably from 0.5 to 4 and in particular from 0.5 to 2 and the degree of ethoxylation (value of y) is generally from 3 to 50, preferably from 4 to 25 and in particular from 5 to 15. The total degree of alkoxylation, i.e. the sum of EO and PeO units, is generally from 3.5 to 70, preferably from 4.5 to 45 and in particular from 5.5 to 17.

According to a particular embodiment, the alcohol alkoxylates of the formula (I) are not end-group-modified, i.e. R² is hydrogen.

According to a preferred embodiment of the invention, the alcohol part of the alcohol alkoxylates is based on alcohols or mixtures of alcohols known per se with from 5 to 30, preferably from 8 to 20 and in particular from 9 to 15 carbon atoms. Mention may be made here in particular of fatty alcohols with from approximately 8 to 20 carbon atoms. Many of these fatty alcohols are, as is known, used for the preparation of nonionic and anionic surfactants, for which the alcohols are subjected to an appropriate functionalization, e.g. by alkoxylation or glycosidation.

The alcohol part can be straight-chain, branched or cyclic. If it is linear, mention may thus in particular be made of alcohols with from 14 to 20, for example with from 16 to 18, carbon atoms. If it is branched, the main chain of the alcohol part generally exhibits, according to a particular embodiment, from 1 to 4 branchings, it also being possible for alcohols with higher or lower degrees of branching to be used in the mixture with additional alcohol alkoxylates, provided that the average number of the branchings of the mixture lies in the given range.

The alcohol part can be saturated or unsaturated. If it is unsaturated, it thus exhibits, according to a particular embodiment, a double bond. Generally, the branchings of the alcohol part exhibit, independently of one another, each time from 1 to 10, preferably from 1 to 6 and in particular from 1 to 4 carbon atoms. Particular branchings are methyl, ethyl, n-propyl or isopropyl groups.

Suitable alcohols and in particular fatty alcohols can be obtained both from native sources, e.g. by extraction and necessarily or optionally by hydrolysis, transesterification and/or hydrogenation of glycerides and fatty acids, and synthetically, e.g. by synthesis from educts with a lower number of carbon atoms. Thus, e.g., olefin fractions with a carbon number suitable for further processing to give surfactants are obtained, starting from ethers, according to the SHOP (Shell Higher Olefine Process) process. The functionalization of the olefins to give the corresponding alcohols is carried out in this connection, e.g. by hydroformylation and hydrogenation.

The alkoxylation results from the reaction with suitable alkylene oxides. The prevailing degree of alkoxylation depends on the dosages of alkylene oxide(s) chosen for the reaction and on the reaction conditions. In this connection, a statistical mean value is generally concerned since the number of alkylene oxide units of the alcohol alkoxylates resulting from the reaction varies.

The degree of alkoxylation, i.e. the mean chain length of the polyether chains of the alcohol alkoxylates to be used according to the invention, can be determined by the molar ratio of alcohol to alkylene oxide. Preference is given to alcohol alkoxylates with from approximately 2 to 100, preferably from approximately 2 to 50, in particular from 3 to 30, above all from 4 to 20 and especially from 5 to 15 alkylene oxide units.

The reaction of the alcohols or alcohol mixtures with the alkylene oxide(s) is carried out according to conventional processes known to a person skilled in the art and in conventional equipment therefor.

The alkoxylation reaction can be catalyzed by strong bases, such as alkali metal hydroxides and alkaline earth metal hydroxides, Brönsted acids or Lewis acids, such as AlCl₃, BF₃, and the like. Catalysts such as hydrotalcite or DMC can be used for narrowly distributed alcohol alkoxylates.

The alkoxylation is preferably carried out at temperatures ranging from approximately 80 to 250° C., preferably from approximately 100 to 220° C. The pressure is preferably between ambient pressure and 600 bar. If desired, the alkylene oxide can comprise an inert gas admixture, e.g. from approximately 5 to 60%.

According to a preferred embodiment, the alcohol alkoxylates to be used according to the invention are based on primary, α-branched alcohols of the formula (II):

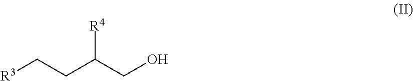

in which
R³ and R⁴ are, independently of one another, hydrogen or C₁-C₂₆-alkyl.

Preferably, R³ and R⁴ are, independently of one another, C₁-C₆-alkyl and in particular

According to a particular embodiment, use is made of alcohol alkoxylates in which 2-propylheptanol is the alcohol part. These include in particular alcohol alkoxylates of the formula (I) in which R¹ is a 2-propylheptyl radical, i.e. R³ and R⁴ in formula (II) represent n-propyl each time.

Such alcohols are also described as Guerbet alcohols. These can, for example, be obtained by dimerization of the corresponding primary alcohols (e.g. R^{3,4}—CH₂CH₂OH) at elevated temperature, for example from 180 to 300° C., in the presence of an alkaline condensation catalyst, such as potassium hydroxide.

According to an additional particular embodiment, use is made of alcohol alkoxylates in which the alcohol part is a C₁₃-oxo alcohol.

It is particularly preferred for these C₁₃-oxo alcohols to be obtained by hydroformylation and subsequent hydrogenation of unsaturated C₁₂-hydrocarbons, in particular by hydrogenation of hydroformylated trimeric butene or by hydrogenation of hydroformylated dimeric hexene.

The term “C₁₃-oxo alcohol” generally describes an alcohol mixture, the main component of which is formed from at least one branched C₁₃-alcohol (isotridecanol). Such C₁₃-alcohols include in particular tetramethylnonanols, for example 2,4,6,8-tetramethyl-1-nonanol or 3,4,6,8-tetramethyl-1-nonanol, and furthermore ethyldimethylnonanols, such as 5-ethyl-4,7-dimethyl-1-nonanol.

Suitable C₁₃-alcohol mixtures can generally be obtained by hydrogenation of hydroformylated trimeric butene. In particular, it is possible
1) to bring butenes, for oligomerization, into contact with a suitable catalyst,
2) to isolate a C₁₂-olefin fraction from the reaction mixture,
3) to hydroformylate the C₁₂-olefin fraction by reaction with carbon monoxide and hydrogen in the presence of a suitable catalyst, and
4) to hydrogenate.

The butene trimerization preceding the hydrogenation can be carried out using homogeneous or heterogeneous catalysis.

A C₁₂-olefin fraction is first isolated in one or more separation stages from the reaction product of the oligomerization reaction described, which fraction is then suitable for the preparation, by hydroformylation and hydrogenation, of usable C₁₃-alcohol mixtures (process stage 2). The conventional devices known to a person skilled in the art are suitable separating devices.

The C₁₂-olefin fraction thus isolated is hydroformylated to give C₁₃-aldehydes (process stage 3) and subsequently hydrogenated to give C₁₃-alcohols (process stage 4) for the preparation of an alcohol mixture according to the invention. In this connection, the alcohol mixtures can be prepared in one stage or in two separate reaction stages.

A review of hydroformylation processes and suitable catalysts appears in Beller et al., Journal of Molecular Catalysis A, 104 (1995), pp. 17-85.

For the hydrogenation, the reaction mixtures obtained in the hydroformylation are reacted with hydrogen in the presence of a hydrogenation catalyst.

Additional suitable C₁₃-alcohol mixtures can be obtained by
1) subjecting a C₄-olefin mixture to metathesis,
2) separating olefins with 6 carbon atoms from the metathesis mixture,
3) subjecting the separated olefins, individually or in the mixture, to a dimerization to give olefin mixtures with 12 carbon atoms, and
4) subjecting the olefin mixture thus obtained, optionally after a fractionation, to the derivatization to give a mixture of C₁₃-oxo alcohols.

The C₁₃-alcohol mixture according to the invention can be obtained pure for use as component (a₁) from the mixture obtained after the hydrogenation according to conventional purification processes known to a person skilled in the art, in particular by fractional distillation.

C₁₃-alcohol mixtures according to the invention generally exhibit a mean degree of branching of from 1 to 4, preferably from 2.0 to 2.5 and in particular from 2.1 to 2.3 (based on trimeric butene) or from 1.3 to 1.8 and in particular from 1.4 to 1.6 (based on dimeric hexene). The number of the methyl groups in a molecule of the alcohol minus 1 is defined as degree of branching. The mean degree of branching is the statistical mean value of the degrees of branching of the molecules of a sample. The mean number of the methyl groups in the molecules of a sample can be readily determined by ¹H NMR spectroscopy. For this, the signal area corresponding to the methyl protons in the ¹H NMR spectrum of a sample is divided by 3 and compared with the signal area, divided by 2, of the methylene protons in the CH₂—OH group.

According to an additional particular embodiment, use is made of alcohol alkoxylates in which the alcohol part is a C₁₀-oxo alcohol. The term “C₁₀-oxo alcohol” represents, analogously to the term “C₁₃-oxo alcohol” already explained, C₁₀-alcohol mixtures having a main component formed from at least one branched C₁₀-alcohol (isodecanol).

It is particularly preferable for suitable C₁₀-alcohol mixtures to be obtained by hydrogenation of hydroformylated trimeric propene.

In particular, it is possible
1) to bring propenes into contact with a suitable catalyst for the purpose of oligomerization,
2) to isolate a C₉-olefin fraction from the reaction mixture,
3) to hydroformylate the C₉-olefin fraction by reaction with carbon monoxide and hydrogen in the presence of a suitable catalyst, and
4) to hydrogenate.

Particular embodiments of this procedure ensue by analogy to the embodiments described above for the hydrogenation of hydroformylated trimeric butene.

It follows, from the above embodiments, that in particular the C₁₃-oxo alcohols or C₁₀-oxo alcohols to be used according to the invention are based on olefins which are already branched. In other words, branchings are not only to be traced back to the hydroformylation reaction, as would be the case in the hydroformylation of straight-chain olefins. Consequently, the degree of branching of the alkoxylates to be used according to the invention is generally greater than 1.

The alcohol alkoxylates to be used according to the invention generally exhibit a relatively low contact angle. Particular preference is given to alkoxylates having a contact angle of less than 120° and preferably of less than 100° when this is determined in a way known per se on a paraffin surface for an aqueous solution comprising 2% by weight of alkoxylate.

According to one aspect, the surface-active properties of the alcohol alkoxylates depend on the type and distribution of the alkoxylate grouping. The surface tension of the alcohol alkoxylates to be used according to the invention, which can be determined according to the pendant drop method, preferably ranges from 25 to 70 mN/m and in particular from 28 to 50 mN/m for a solution comprising 0.1% by weight of alcohol alkoxylate and ranges from 25 to 70 mN/m and in particular from 28 to 45 mN/m for a solution comprising 0.5% by weight of alcohol alkoxylate. Alkoxylates preferably to be used according to the invention accordingly qualify as amphiphilic substances.

Typical commercial products of the formula (I) are familiar to a person skilled in the art. They are, e.g., offered for sale by BASF SE under the general brand name of the “Lutensoles”, Lutensoles of the series A, AO, AT, ON, AP, FA, TO, XP, XL and XA being differentiated according to base alcohol. Furthermore, included numbers give the degree of ethoxylation. Thus, e.g., “Lutensol AO 8” is a C₁₃₋₁₅-oxo alcohol with eight EO units. Mention may also be made here of the alcohol alkoxylates sold under the Plurafac brand name, e.g. Plurafac LF 120, 131, 132, 220, 221, 223, 224, 226, 231, 300, 301, 303, 305, 400, 401, 403, 404, 431, 500, 600, 711, 1200 and 1300.

Additional examples of polyalkoxylates according to the invention are products from Akzo, e.g. the “Ethylan” series based on linear or branched alcohols. Thus, e.g., “Ethylan SN 120” is a C₁₀₋₁₂-alcohol with ten EO units and “Ethylan 4 S” is a C₁₂₋₁₄-alcohol with four EO units.

Additional examples of alcohol alkoxylates according to the invention are castor oil ethoxylates (castor oil-EOₓ), e.g. products of the “Emulphon CO” or “Emulphon EL” product series from Akzo, such as, for example, “Emulphon CO 150” with 15 EO units.

Alcohol alkoxylates according to the invention also comprise “narrow range” products. The expression “narrow range” refers in this connection to a fairly narrow distribution in the number of the EO units. These include, e.g., products of the “Berol” series from Akzo.

Mixtures of different alcohol alkoxylates can also be used as component (a).

Alcohol alkoxylates of the formula (I) exhibiting at least one terminally arranged block of alkylene oxide with more than 2 carbon atoms (in particular a PO, BO or PeO block) are in particular of importance according to the invention. These include the hereindisclosed EO-PO, EO-BO and EO-PeO block alkoxylates each with a proximal EO block.

According to a particular embodiment of the invention, the proportion of alcohol alkoxylate is at least 1% by weight, preferably at least 5% by weight and in particular at least 10% by weight, based on the total weight of the composition.

According to an additional particular embodiment of the invention, the composition comprises at most 50% by weight, preferably at most 40% by weight and in particular at most 30% by weight of alcohol alkoxylate.

Use may generally be made of cyclodextrins as cyclodextrin component (b). The term “cyclodextrin” stands here for cyclic oligosaccharides formed from glucose molecules connected via α-1,4-glycoside bonds which can be obtained by enzymatic decomposition of starch. They comprise a Greek letter as prefix, depending on the number of glucose molecules from which they are built. α-, β-, γ- and δ-cylodextrins with 6, 7, 8 or 9 glucose molecules are especially of importance.

The cyclodextrins according to the invention also include modified cyclodextrins. Modified cyclodextrins can in particular be obtained by modifying one or more of the primary and/or secondary hydroxyl groups. For example, it is possible to alkylate or hydroxyalkylate the hydroxyl groups (i.e., alkylated or hydroxyalkylated cyclodextrins) so that —OR or —CH₂OR group are produced in which R is alkyl, preferably C₁-C₄-alkyl, in particular methyl, ethyl or propyl; hydroxyalkyl, preferably hydroxy-C₁-C₄-alkyl, in particular hydroxymethyl, hydroxyethyl (1-hydroxyethyl or 2-hydroxyethyl), or hydroxypropyl (1-hydroxypropyl, 2-hydroxypropyl or 3-hydroxypropyl); or -[alkylene-O—]ₙ—H, preferably methylene-O—]ₙ—H, in particular -[ethylene-O—]ₙ—H, or -[propylene-O—]ₙ—H (e.g., -[1,1-propylene-O—]ₙ—H, -[1,2-propylene-O—]ₙ—H or -[1,3-propylene-O—ₙ]—H), n being greater than 1 and preferably less than 5.

Such cyclodextrins are generally known to a person skilled in the art and may in some cases also be available for sale. Mention may for example be made here of the cyclodextrins sold under the Cavamax® and Cavasol® brand names by Wacker Chemie AG, Germany.

Cyclodextrins exhibit a cavity through which they are able to entrap compounds. This property of cyclodextrins appears to be of importance for the use of cyclodextrins in the suspension concentrates according to the invention. In this sense, the size of the cavity influences the ability of a cyclodextrin to form an inclusion complex with a particular compound. It turns out according to the invention that α-, β-, and γ-cyclodextrins and of these in particular α- and β-cyclodextrins are to be preferred.

The choice between a natural or modified cyclodextrin is less of importance according to the invention. Thus, it is up to a person skilled in the art to use either a natural or suitably modified cyclodextrin which meets the requirements for the ability to form an inclusion complex with a particular compound and also for the other properties, such as, for example, the solubility of the cyclodextrin.

It is particularly preferable in this connection for the plant protection composition to comprise at least 0.5% by weight, preferably at least 5% by weight and in particular at least 10, 15 or % by weight of cyclodextrin.

It is also particularly preferable in this connection for the plant protection composition to comprises at most 50% by weight, preferably at most 45% by weight and in particular at most 40% by weight of cyclodextrin.

The suspension concentrates according to the invention comprise relatively high amounts of alcohol alkoxylate. With reference to the amount of alcohol alkoxylate, it is preferable for the ratio by weight of cyclodextrin to alcohol alkoxylate to be 0.5:1, preferably at least 1:1 and particularly preferably at least 2:1. In this connection, the proportion of alcohol alkoxylate can also be greater than the proportion of cyclodextrin but preferably at most up to a ratio by weight of 5:1, 4:1 or 3:1.

Generally, the suspension concentrates according to the invention comprise, in addition to the components a) and b), another auxiliary as component c).

The component (c) can serve a multitude of purposes. Generally, component c) accordingly is composed of a combination of several materials with different functions and properties. The choice of suitable auxiliaries is made conventionally by a person skilled in the art according to the requirements.

The following are suitable in particular as component (c):
(c1) surface-active auxiliaries;
(c2) suspension agents (thickeners), antifoaming agents, antifreeze agents and bactericides; and/or
(c3) other auxiliaries for improving the handleability and/or physical properties of the composition.

The term “surface-active auxiliary” (c1) describes here surface-active agents (also described subsequently as surfactants), such as dispersants, emulsifiers or wetters.

The type of the surface-active auxiliary to be chosen is not particularly critical according to the invention, i.e. it can be chosen from known surface-active auxiliaries, in particular dispersants, emulsifiers and wetters. It should, though, be taken into consideration that the alcohol alkoxylates are already included among the surface-active auxiliaries and thus that this should be taken into account with regard to the type and the amount of additional surface-active auxiliary.

Dispersants are surface-active auxiliaries which first bind to the surface of the active agent particles via an ionic and/or hydrophobic interaction and stabilize the particles in the fluid phase. Wetters are surface-active auxiliaries which first lower the surface tension between the fluid phase and the solid particles dispersed in the fluid phase, resulting in the particles becoming stabilized in the fluid phase. Wetters can be chosen with the help of physical measurements of the contact angle. Particularly suitable wetters have a contact angle of less than 90°, in particular of less than 60° (determined at 24° C./1013 mbar on a 1M aqueous solution of the wetter according to DIN 53914 with the Wilhelm method or according to the upgraded Washburn method using active agent powder).

Anionic surfactants include in particular:
nonpolymeric anionic surfactants with an SO₃⁻ or PO₃²⁻ group, e.g.
   c.1 C₈-C₂₂-alkylsulfonates, such as laurylsulfonate and isotridecylsulfonate;
   c.2 C₈-C₂₂-alkyl sulfates, such as lauryl sulfate, isotridecyl sulfate, cetyl sulfate ad stearyl sulfate;
   c.3 aryl- and C₁-C₁₆-alkylarylsulfonates, such as naphthalenesulfonate, mono-, di- and tri-C₁-C₁₆-alkylnaphthylsulfonates, such as dibutylnaphthylsulfonates, dodecyldiphenyl ether sulfonates, or mono-, di- and tri-C₁-C₁₆-alkylphenylsulfonates, such as cumylsulfonate, octylbenzenesulfonate, nonylbenzenesulfonate, dodecylbenzenesulfonate and isotridecylbenzenesulfonate;
   c.4 sulfates and sulfonates of fatty acids with preferably from 6 to 22 carbon atoms and of fatty acid esters with preferably from 6 to 22 carbon atoms;
   c.5 sulfates of ethoxylated C₈-C₂₂-alkanols, for example the sulfates of (poly)ethoxylated lauryl alcohol;
   c.6 sulfates of (poly)ethoxylated C₄-C₁₆-alkylphenols;
   c.7 mono- and diesters of phosphoric acid, including the mixtures thereof with triesters of phosphoric acid, in particular the esters with C₈-C₂₂-alkanols, with ethoxylated C₈-C₂₂-alkanols, with C₄-C₂₂-alkylphenols, with (poly)ethoxylated C₄-C₂₂-alkylphenols, with di- or tristyrylphenols and with (poly)ethoxylated di- or tristyrylphenols, and also mixtures thereof;
   c.8 di-C₄-C₂₂-alkyl esters of sulfosuccinic acid, such as dioctyl sulfosuccinate.
polymeric anionic surfactants with an SO₃⁻ or PO₃²⁻ group, e.g.
   c.9 condensates of arylsulfonic acid with formaldehyde and optionally with urea.
nonpolymeric anionic surfactants with at least one carboxylate group, e.g.
   c.10 fatty acids, such as stearates, and
   c.11 N—C₆—C₂₂-acylglutamates.
polymeric anionic surfactants with at least one carboxylate group, e.g.
   c.12 anionic graft copolymers exhibiting, on a polymeric backbone, grafted polyethylene oxide PEO units and exhibiting carboxylate groups bonded to the polymeric backbone.
   c.13 anionic copolymers exhibiting, in polymerized form, (i) monoethylenically unsaturated C₃-C₅-carboxylic acid monomers, and alternatively (ii) hydrophobic monomers with a solubility in water of not more than 60 g/l at 20° C. and 1013 mbar.

Preference is given to the sodium, potassium, calcium and ammonium salts of the anionic surfactants.

Preference is given, from the group c.3, to mono- or di-C₄-C₈-alkylnaphthalenesulfonic acid and mono- or di-C₄-C₁₆-alkylbenzenesulfonic acid and the alkali metal salts thereof, such as the sodium or potassium salt, and the alkaline earth metal salts, in particular the calcium salts, thereof. A particularly suitable example is Morwet® EFW (Akzo Nobel).

Preference is given, from the group c.8, to the alkali metal salts of di(C₆-C₁₂-alkyl) sulfosuccinates, C₆-C₁₂-alkyl being a straight-chain or branched alkyl group with from 6 to 12 carbon atoms, e.g. n-hexyl, n-heptyl, n-octyl, n-nonyl, n-decyl, n-dodecyl, 2-hexyl, 2-heptyl, 2-octyl, 2-nonyl and 2-ethylhexyl. Use is preferably made of an alkali metal dioctyl sulfosuccinate, it being possible for the octyl unit to be linear or branched and the alkali metal being chosen from sodium and potassium. A particularly preferred example is Aerosol® OTB (Cytec).

From the group c.9, the arylsulfonic acids can, for example, be phenolsulfonic acids and naphthalenesulfonic acids which are unsubstituted or substituted with one or more, e.g. 1, 2, 3 or 4, C₁-C₂₀ alkyl groups. According to a preferred embodiment, the surfactant c.9 is an alkali metal salt or alkaline earth metal salt of a reaction product (condensate) of naphthalenesulfonic acid and formaldehyde; a particularly preferred example is Morwet® D425 (Akzo Nobel).

Preferred graft copolymers from the group c.12 comprise, in polymerized form, (i) monoethylenically unsaturated C₃-C₅-carboxylic acid monomers, such as acrylic acid, methacrylic acid and maleic acid, (ii) polyethylene oxide groups bonded to the polymer backbone either via ester bonds or ether bonds and optionally (iii) hydrophobic monomers with a solubility in water of not more than 60 g/l at 20° C. and 1013 mbar, e.g. C₁-C₈-alkyl esters of C₃-C₅ monoethylenically unsaturated carboxylic acid monomers, such as C₁-C₈-alkyl acrylates and methacrylates, vinylaromatic monomers, such as styrene, and C₂-C₁₂-monoolefins, such as ethene, propene, 1-butene, isobutene, hexene, 2-ethylhexene, diisobutene (mixture of isobutene dimers), tripropene, tetrapropene, triisobutene, and the like. According to a preferred embodiment, the anionic backbone of the surfactant c.12 comprises, in polymerized form, methacrylic acid, methyl methacrylate and polyethylene oxide ester of methacrylic acid.

Preferred polymeric surfactants of the group c.13 are those comprising, in polymerized form, (i) at least one monoethylenically unsaturated C₃-C₅-carboxylic acid monomer and (ii) at least one hydrophobic monomer as defined above. Suitable monoethylenically unsaturated C₃-C₅-carboxylic acid monomers and suitable hydrophobic monomers are those mentioned in group c.13. Preferred monoethylenically unsaturated C₃-C₅-carboxylic acid monomers include acrylic acid, methacrylic acid and maleic acid. Preferred hydrophobic monomers should be chosen from vinylaromatic monomers, such as styrene monomers, and C₂-C₁₂-monoolefins. Preferably, the surfactants c.13 comprise, in polymerized form, (i) at least one monoethylenically unsaturated C₃-C₅-carboxylic acid monomer, in particular acrylic acid or methacrylic acid, and (ii) at least one hydrophobic monomer chosen from styrene monomers and C₂-C₁₂-monoolefins. The ratio by weight of acid monomer to hydrophobic monomer preferably ranges from 10:1 to 1:3, preferably from 5:1 to 1:2. A particularly suitable example of a surfactant c.13 is Atlox® Metasperse 500 L (Uniqema).

### Nonionic Surfactants Include in Particular

c.14 polyethylene glycol C₁-C₂₂-alkyl ethers, polyethylene glycol/polypropylene glycol C₁-C₂₂-alkyl ethers, in particular polyethoxylates and poly(ethoxylate-co-propoxylate)s of linear or branched C₈-C₂₀-alkanols, more preferably polyethoxylated C₈-C₂₂-fatty alcohols and polyethoxylated C₈-C₂₂-oxo alcohols, such as polyethoxylated lauryl alcohol, polyethoxylated isotridecanol, polyethoxylated cetyl alcohol, polyethoxylated stearyl alcohol, poly(ethoxylate-co-propoxylate)s of lauryl alcohol, poly(ethoxylate-co-propoxylate)s of cetyl alcohol, poly(ethoxylate-co-propoxylate)s of isotridecyl alcohol or poly(ethoxylate-co-propoxylate)s of stearyl alcohol, and esters thereof, such as acetates;
c.15 polyethylene glycol aryl ethers and polyethylene glycol/polypropylene glycol aryl ethers, in particular polyethoxylates and poly(ethoxylate-co-propoxylate)s of mono- or di-C₁-C₁₆-alkylphenols, such as polyethoxylates and poly(ethoxylate-co-propoxylate)s of nonylphenol, decylphenol, isodecylphenol, dodecylphenol or isotridecylphenol, or polyethoxylates and poly(ethoxylate-co-propoxylate)s of mono-, di- and tristyrylphenols; and the esters thereof, e.g. the acetates;
c.16 C₆-C₂₂-alkylglucosides and C₆-C₂₂-alkylpolyglucosides;
c.17 partial esters of polyols with C₆-C₂₂-alkanoic acids, in particular mono- and diesters of glycerol and mono-, di- and triesters of sorbitan, such as glycerol monostearate, sorbitan monooleate and sorbitan tristearate;
c.18 polyethoxylates of C₆-C₂₂-alkylglucosides and polyethoxylates of C₆-C₂₂-alkylpolyglucosides;
c.19 polyethoxylates and poly(ethoxylate-co-propoxylate)s of C₆-C₂₂-fatty amines;
c.20 polyethoxylates and poly(ethoxylate-co-propoxylate)s of C₆-C₂₂-fatty acids and polyethoxylates and poly(ethoxylate-co-propoxylate)s of hydroxyl-C₆-C₂₂-fatty acids;
c.21 polyethoxylates of partial esters of polyols with C₆-C₂₂-alkanoic acids, in particular polyethoxylates of mono- and diesters of glycerol and polyethoxylates of mono-, di- and triesters of sorbitan, such as polyethoxylates of glycerol monostearate, polyethoxylates of sorbitan monooleate, polyethoxylates of sorbitan monostearate and polyethoxylates of sorbitan tristearate;
c.22 polyethoxylates of vegetable oils or animal fats, such as corn oil ethoxylate, castor oil ethoxylate and tall oil ethoxylate;
c.23 polyethoxylates of fatty amines, fatty amides or fatty acid diethanolamides;
c.24 polyethoxylates and poly(ethoxylate-co-propoxylate)s of mono-, di- and tristyrylphenols; and the esters thereof, e.g. the acetates; and
c.25 nonionic block copolymers comprising at least one poly(ethylene oxide) unit PEO and at least one polyether unit derived from C₃-C₁₀-alkylene oxides PAO and/or styrene oxide, in particular polyoxyethylene-polyoxypropylene block copolymers; and
c.26 nonionic graft copolymers comprising polyethylene oxide units PEO grafted to a nonionic polymeric backbone.

The terms polyethylene glycols, polyethoxylates and polyethoxylated refer to polyether radicals which derive from ethylene oxide. Analogously, the term poly(ethoxylate-co-propoxylate) refers to a polyether radical which is derived from a mixture of ethylene oxide and propylene oxide. Polyethoxylates accordingly exhibit repeat units of the formula [CH₂CH₂O], while poly(ethoxylate-co-propoxylate)s exhibit repeat units of the formulae [CH₂CH₂O] and [CH(CH₃)CH₂O]. The surfactants c.14, c.15 and c.18 to c.24 can belong to the group of the nonpolymeric surfactants or the group of the polymeric surfactants, depending on the number of alkylene oxide repeat units. In the surfactants of these groups, the number of such repeat units generally lies in the range from 2 to 200, in particular from 3 to 100, particularly from 3 to 50. The surfactants of groups c.17 and c.18 belong to nonpolymeric surfactants, while the surfactants of groups c.25 and c.26 are usually polymeric surfactants.

Preference is given, from the group of the surfactants c.14, to polyethoxylates and poly(ethoxylate-co-propoxylate)s of linear C₈-C₂₂-alkanols. Analogously, preference is given to poly(ethoxylate-co-propoxylate)s of C₁-C₁₀-alkanols, in which in particular butanol should be emphasized. Preference is given, for the surfactant c.14, to those exhibiting a number-average molecular weight M_{N} of not more than 5000 daltons. Particularly preferred are poly(ethoxylate-co-propoxylate)s of C₁-C₁₀-alkanols with a number-average molecular weight M_{N} of 500 to 5000 daltons. Particularly suitable examples include Atlox® G 5000 (Akzo Nobel) and Tergitol®XD.

For the surfactants of the group c.25, a phenoxy radical carries 1, 2 or 3 styryl units and a polyethylene oxide unit PEO or a poly(ethylene oxide-co-propylene oxide) unit PEO/PPO. The PEO unit typically comprises from 5 to 50 ethylene oxide groups. Preferred surfactants c.24 can be denoted by the formula (C₂H₄O)ₙ.C₃₀H₃₀O, in which n is an integer from 5 to 50 and C₃₀H₃₀O is a tri(styryl)phenol group. A particularly suitable example is Soprophor® BSU (Rhodia).

The nonionic block copolymers of the surfactant category c.25 comprise at least one poly(ethylene oxide) unit PEO and at least one hydrophobic polyether unit PAO. The PAO unit typically comprises at least 3, preferably at least 5 and in particular from 10 to 100 repeat units (number-average) deriving from C₃-C₁₀-alkylene oxides, such as propylene oxide, 1,2-butylene oxide, cis- or trans-2,3-butylene oxide or isobutylene oxide, 1,2-pentene oxide, 1,2-hexene oxide or 1,2-decene oxide, and styrene oxide, of which C₃-C₄-alkylene oxides are preferred. Preferably, the PAO units comprise at least 50% by weight and more preferably at least 80% by weight of repeat units derived from propylene oxide. The PEO units comprise typically at least 3, preferably at least 5 and more preferably at least 10 repeat units derived from ethylene oxide (number-average). The ratio by weight of PEO units to PAO units (PEO:PAO) usually lies in the range from 1:10 to 10:1, preferably from 1:10 to 2:1, more preferably from 2:8 to 7:3 and in particular from 3:7 to 6:4. Preference is given to those surfactants exhibiting a number-average molecular weight M_{N} in the range from 1200 to 100 000 daltons, preferably from 2000 to 60 000 daltons, more preferably from 2500 to 50 000 daltons and in particular from 3000 to 20 000 daltons. Generally, the PEO units and the PAO units make up at least 80% by weight and preferably at least 90% by weight, e.g. from 90 to 99.5% by weight, of the nonionic block copolymer surfactant. Suitable surfactants are described, for example, in WO2006/002984, in particular those with the formulae P1 to P5 given therein.

The nonionic block copolymer surfactants of the group c. 25 can, for example, be obtained commercially under the following brand names: Pluronic®, such as Pluronic®P 65, P84, P 103, P 105 and P 123 and Pluronic® L 31, L 43, L 62, L 62 LF, L 64, L 81, L 92 and L 121, Pluraflo®, such as Pluraflo® L 860, L1030 and L 1060; Tetronic®, such as Tetronic® 704, 709, 1104, 1304, 702, 1102, 1302, 701, 901, 1101 and 1301 (BASF Aktiengesellschaft), Agrilan® AEC 167 and Agrilan® AEC 178 (Akcros Chemicals), Antarox® B/848 (Rhodia), Berol® 370 and Berol® 374 (Akzo Nobel Surface Chemistry), Dowfax® 50 C15, 63 N10, 63 N30, 64 N40 and 81 N10 (Dow Europe), Genapol® PF (Clariant), Monolan®, such as Monolan® PB, Monolan® PC or Monolan® PK (Akcros Chemicals), Panox® PE (Pan Asian Chemical Corporation), Synperonic®, such as Synperonic® PE/L, Synperonic® PE/F, Synperonic® PE/P and Synperonic® PENT (ICI Surfactants), Tergitol® XD, Tergitol® XH and Tergitol® XJ (Union Carbide), Triton® CF-32 (Union Carbide), Teric PE series (Huntsman) and Witconol®, such as Witconol® APEB and Witconol® NS 500 K and the like. Preference is given, among these, to the block copolymers of the Pluronic® and Pluraflo® brand names, Pluronic® P105 and Pluraflo® 1060 and the like, for example, being particularly suitable.

Preferred graft copolymers of the group c.26 comprise, in polymerized form, (i) methyl esters or hydroxyl-C₂-C₃-alkyl esters of monoethylenically unsaturated C₃-C₅-carboxylic acid monomers, such as methyl acrylate, methyl methacrylate, hydroxyethyl acrylate and hydroxyethyl methacrylate, and (ii) polyethylene oxide groups bonded to the polymer backbone either via ester bonds or ether bonds. According to a preferred embodiment, the backbone of the surfactant c.26 comprises, in polymerized form, methyl methacrylate and polyethylene oxide esters of methacrylic acid, Atlox® 4913 (Akzo Nobel), for example, being particularly suitable.

Preferably, the nonionic block copolymer surfactants from the group c.25 are used as dispersants in the suspension concentrates according to the invention.

The proportion of the surface-active auxiliary component (c1) to the total weight of the composition is—if present—generally up to 25% by weight, preferably up to 20% by weight, especially up to 15% by weight and in particular up to 10% by weight, based on the total weight of the composition.

The suspension agents, antifoaming agents, antifreeze agents and bactericides comprise a multitude of possible substances. They are familiar to a person skilled in the art.

Use is made, as suspension agents or antisettling agents, in particular of thickeners (i.e., compounds which bestow a modified flow behavior on the formulation, i.e. high viscosity at rest and low viscosity in the agitated state), e.g. polysaccharides, such as xanthan gum (Kelzan® from Kelco), Rhodopol® 23 (Rhone-Poulenc) or Veegum®(R. T. Vanderbilt), and also organic and inorganic layered minerals, such as Attaclay®(Engelhardt).

The antifreeze agents include, e.g., C₁-C₄-alkanols, such as ethanol, isopropanol, n-butanol or isobutanol, and also C₂-C₆-polyols, such as glycerol, ethylene glycol, hexylene glycol and/or propylene glycol.

Examples of antifoaming agents are silicone emulsions (such as, e.g., Silikon® SRE, from Wacker or Rhodorsil® from Rhodia), long-chain alcohols, fatty acids, salts of fatty acids, e.g. magnesium stearate, fluoroorganic compounds and the mixtures thereof.

Bactericides can be added for the stabilization. Examples of bactericides are bactericides based on dichlorophen and benzyl alcohol hemiformal (Proxel® from ICI or Acticide® R S from Thor Chemie and Kathon® M K from Röhm & Haas) and also isothiazolinone derivatives, such as alkylisothiazolinones and benzisothiazolinones (Acticide MBS from Thor Chemie).

The proportion of the auxiliary component (c2) to the total weight of the composition is—if present—generally up to 15% by weight, preferably up to 10% by weight and in particular up to 5% by weight, based on the total weight of the composition.

The compositions can also comprise colorants. This is in particular the case if the compositions are intended for seed treatment. Examples of colorants are both pigments which are sparingly soluble in water and colorants which are soluble in water. Mention may be made, as examples, of the colorants known under the descriptions Rhodamine B, C.I. Pigment Red 112 and C.I. Solvent Red 1, and also Pigment Blue 15:4, Pigment Blue 15:3, Pigment Blue 15:2, Pigment Blue 15:1, Pigment Blue 80, Pigment Yellow 1, Pigment Yellow 13, Pigment Red 112, Pigment Red 48:2, Pigment Red 48:1, Pigment Red 57:1, Pigment Red 53:1, Pigment Orange 43, Pigment Orange 34, Pigment Orange 5, Pigment Green 36, Pigment Green 7, Pigment White 6, Pigment Brown 25, Basic Violet 10, Basic Violet 49, Acid Red 51, Acid Red 52, Acid Red 14, Acid Blue 9, Acid Yellow 23, Basic Red 10 and Basic Red 108.

It is generally preferable for the composition to comprise in total at most 60% by weight, preferably at most 45% by weight and in particular at most 30% by weight of additional auxiliary (c).

Typically, the ratio by weight of the components (a) and (b) to (c) is at least 3, preferably at least 5.

The suspension concentrates according to the invention comprise, in addition to the components a) and b), as component d), usually a fluid, preferably a liquid, in which at least a portion of the active agent is suspended. For this, the solubility of the active agent in the fluid should not be more than 2 g/l at 25° C./1013 mbar.

The fluid can also be used for the incorporation of additional ingredients, for example of dissolved, dispersed or suspended form. The choice of suitable fluids is made according to the requirements, usually by a person skilled in the art.

The following are possible in particular as component (d):
(d1) water, and
(d2) polyhydric C₂-C₄-alcohols.

Preferred polyhydric C₂-C₄-alcohols in this connection are ethylene glycol, 1,2-propanediol, 1,3-propanediol, glycerol and 1,4-butanediol, ethylene glycol and 1,3-propanediol being emphasized.

According to a preferred embodiment, the fluid is composed essentially of water, i.e. water makes up at least 99% by weight of the total weight of the fluid (component (d)). According to an additional embodiment, the fluid is a mixture of water and at least one of the abovementioned polyhydric C₂-C₄-alcohols. In this case, the ratio by weight of water to polyhydric alcohol preferably lies in the range from 99:1 to 1:1, more preferably in the range from 50:1 to 2:1 and in particular in the range from 40:1 to 10:1. This includes in particular fluids comprising more than 50% by weight of a polyhydric C₂-C₄-alcohol or a mixture of polyhydric C₂-C₄-alcohols, based on the total weight of the fluid (component (d)).

It is generally preferable for the composition to comprise in total at least 10% by weight, preferably at least 20% by weight and in particular at least 30% by weight of component d1).

According to another aspect, it is preferable for the composition to comprise in total at most 80% by weight, preferably at most 70% by weight and in particular at most 60% by weight of component d1).

According to a particular embodiment of the present invention, at least a portion of the active agent is present in the suspension concentrates in the form of dispersed particles, the volume-average diameter of which, determined using dynamic light scattering, is less than 1 μm, for example not more than 900 nm, 800 nm, 700 nm or 500 nm, e.g. from 10 up to <100 nm, 20 to 900 nm, 50 to 800 nm, 70 to 700 nm or 100 to 500 nm.

The mean particle diameters described here are volume-average particle diameters d (0.5) or d (v 0.5), i.e. 50% by volume of the particles have a diameter lying above the mean value given and 50% of the particles have a diameter lying below the mean value given. Such mean particle diameters can be determined using dynamic light scattering, usually carried out on dilute suspensions comprising from 0.01 to 1% by weight of active agent. These methods are known to a person skilled in the art and are described, for example, in H. Wiese (D. Distler, Ed.), Wässrige Polymerdispersionen (Aqueous Polymer Dispersions), Wiley-VCH 1999, Chapter 4.2.1, pp 40ff, and the literature cited therein; H. Auweter and D. Horn, J. Colloid Interf. Sci., 105 (1985), p. 399; D. Lilge and D. Horn, Colloid Polym. Sci. 269 (1991), p. 704; and H. Wiese and D. Horn, J. Chem. Phys. 94 (1991), p. 6429.

In this conneciton, any substance may be described as plant protection active agent (pesticide) of the component (e) which has the purpose or effect of preventing infection of a plant by any pest or of repelling, deterring or destroying the pest or of reducing in another way the damage caused by it. As stated above, plant pests can belong to different groups of organisms; the higher animals, in particular insects and acarids, include numerous important pests, as do nematodes and snails; vertebrates, such as mammals and birds, are today of secondary importance in industrialized countries. Numerous groups of microbes, including fungi, bacteria, inclusive of mycoplasmas, viruses and viroids, comprise pests, and even weeds, which compete with useful plants for limited habitat and other resources, can be classed as pests in the broad sense. Pesticides comprise in particular avicides, acaricides, desiccants, bactericides, chemosterilants, defoliants, antifeedants, fungicides, herbicides, herbicide safeners, insect attractants, insecticides, insect repellents, molluscicides, nematicides, mating disrupters, plant activators, plant growth regulators, rodenticides, mammal repellents, synergists, bird repellents and virucides.

Pesticides comprise, classified according to chemical classes, in particular acylalanine fungicides, acylamino acid fungicides, aliphatic amide organothiophosphate insecticides, aliphatic organothiophosphate insecticides, aliphatic nitrogen fungicides, amide fungicides, amide herbicides, anilide fungicides, anilide herbicides, inorganic fungicides, inorganic herbicides, inorganic rodenticides, antiauxins, antibiotic acaricides, antibiotic fungicides, antibiotic herbicides, antibiotic insecticides, antibiotic nematicides, aromatic acid fungicides, aromatic acid herbicides, arsenical herbicides, arsenical insecticides, arylalanine herbicides, aryloxyphenoxypropionic acid herbicides, auxins, avermectin acaricides, avermectin insecticides, benzamide fungicides, benzanilide fungicides, benzimidazole fungicides, benzimidazole precursor fungicides, benzimidazolylcarbamate fungicides, benzoic acid herbicides, benzofuranyl alkylsulfonate herbicides, benzofuranyl methylcarbamate insecticides, benzothiazole fungicides, benzothiopyran organothiophosphate insectides, benzotriazine organothio-phosphate insecticides, benzoylcyclohexanedione herbicides, bipyridylium herbicides, bridged diphenyl acaricides, bridged diphenyl fungicides, carbamate acaricides, carbamate fungicides, carbamate herbicides, carbamate insecticides, carbamate nematicides, carbanilate fungicides, carbanilate herbicides, quinolinecarboxylate herbicides, quinoline fungicides, quinone fungicides, quinoxaline acaricides, quinoxaline organothiophosphate insecticides, quinoxaline fungicides, chitin synthesis inhibitors, chloroacetanilide herbicides, chloronicotinyl insecticides, chloropyridine herbicides, chlorotriazine herbicides, conazole fungicides, coumarin rodenticides, cyclodithiocarbamate fungicides, cyclohexene oxime herbicides, cyclopropylisoxazole herbicides, cytokinins, diacylhydrazine insecticides, dicarboximide fungicides, dicarbox-imide herbicides, dichlorophenyl dicarboximide fungicides, dimethylcarbamate insecticides, dinitroaniline herbicides, dinitrophenol acaricides, dinitrophenol fungicides, dinitrophenol herbicides, dinitrophenol insecticides, diphenyl ether herbicides, dithio-carbamate fungicides, dithiocarbamate herbicides, defoliants, ethylene releasers, fluorine insecticides, furamide fungicides, furanilide fungicides, gibberellins, halogenated aliphatic herbicides, urea fungicides, urea herbicides, urea insecticides, urea rodenticides, molting hormones, molting hormone mimics, molting inhibitors, heterocyclic organothiophosphate insecticides, imidazole fungicides, imidazolinone herbicides, indandione rodenticides, insect growth regulators, isoindole organothio-phosphate insecticides, isoxazole organothiophosphate insecticides, juvenile hormones, juvenile hormone mimics, copper fungicides, macrocyclic lactone acaricides, macrocyclic lactone insecticides, methoxytriazine herbicides, methylthio-triazine herbicides, milbemycin acaricides, milbemycin insecticides, mite growth regulators, morphactins, morpholine fungicides, nereistoxin analogs, nicotinoid insecticides, nitrile herbicides, nitroguanidine insecticides, nitromethylene insecticides, nitrophenyl ether herbicides, organochlorine acaricides, organochlorine insecticides, organochlorine rodenticides, organophosphate acaricides, organophosphate insecticides, organophosphate nematicides, organophosphorus acaricides, organophosphorus fungicides, organophosphorus herbicides, organophosphorus insecticides, organophosphorus nematicides, organophosphorus rodenticides, organothiophosphate acaricides, organothiophosphate insecticides, organothio-phosphate nematicides, organotin acaricides, organotin fungicides, oxadiazine insecticides, oxathiine fungicides, oxazole fungicides, oxime carbamate acaricides, oxime carbamate nematicides, oxime carbamate insecticides, oxime organothio-phosphate insecticides, botanical insecticides, botanical rodenticides, phenoxybutyric acid herbicides, phenoxyacetic acid herbicides, phenoxy herbicides, phenoxypropionic acid herbicides, phenylenediamine herbicides, phenyl ethylphosphonothioate insecticides, phenylurea herbicides, phenyl methylcarbamate insecticides, phenyl organothiophosphate insecticides, phenyl phenylphosphonothioate insecticides, phenyl pyrazolyl ketone herbicides, phenylsulfamide acaricides, phenylsulfamide fungicides, phosphonate acaricides, phosphonate insecticides, phosphonothioate insecticides, phosphoramidate insecticides, phosphoramidothioate acaricides, phosphoramido-thioate insecticides, phosphorodiamide acaricides, phosphorodiamide insecticides, phthalate herbicides, phthalimide acaricides, phthalimide fungicides, phthalimide insecticides, picolate herbicides, polymeric dithiocarbamate fungicides, polysulfide fungicides, precocenes, pyrazole acaricides, pyrazole fungicides, pyrazole insecticides, pyrazolopyrimidine organothiophosphate insecticides, pyrazolyloxyacetophenone herbicides, pyrazolylphenyl herbicides, pyrethroid acaricides, pyrethroid ester acaricides, pyrethroid ester insecticides, pyrethroid ether acaricides, pyrethroid ether insecticides, pyrethroid insecticides, pyridazine herbicides, pyridazinone herbicides, pyridine fungicides, pyridine herbicides, pyridine organothiophosphate insecticides, pyridylmethylamine insecticides, pyrimidinamine acaracides, pyrimidinamine insecticides, pyrimidinamine rodenticides, pyrimidinediamine herbicides, pyrimidine organothiophosphate insecticides, pyrimidine fungicides, pyrimidinyloxybenzoic acid herbicides, pyrimidinylsulfonylurea herbicides, pyrimidinylthiobenzoic acid herbicides, pyrrole acaricides, pyrrole fungicides, pyrrole insecticides, quaternary ammonium herbicides, strobilurin fungicides, sulfite ester acaricides, sulfonamide fungicides, sulfonamide herbicides, sulfonanilide fungicides, sulfonanilide herbicides, sulfonylurea herbicides, tetrazine acaracides, tetronate acaricides, tetronate insecticides, thiadiazole organothiophosphate insecticides, thiadiazolylurea herbicides, thiazole fungicides, thiocarbamate acaricides, thiocarbamate fungicides, thiocarbamate herbicides, thiocarbonate herbicides, thiourea acaricides, thiourea herbicides, thiourea rodenticides, thiophene fungicides, triazine fungicides, triazine herbicides, triazinone herbicides, triazinylsulfonylurea herbicides, triazole fungicides, triazole herbicides, triazolone herbicides, triazolopyrimidine herbicides, triazole organothiophosphate insecticides, uracil herbicides, valinamide fungicides, growth inhibitors, growth stimulators, growth retardants and xylylalanine fungicides.

The pesticide for use according to the invention is chosen in particular from fungicides (e1), herbicides (e2) and insecticides (e3).

Fungicides comprise, for example, aliphatic nitrogen fungicides, such as butylamine, cymoxanil, dodicin, dodine, guazatine or iminoctadine; amide fungicides, such as carpropamid, chioraniformethan, cyflufenamid, diclocymet, ethaboxam, fenoxanil, flumetover, furametpyr, mandipropamid, penthiopyrad, prochloraz, quinazamid, silthiofam or triforine; in particular acylamino acid fungicides, such as benalaxyl, benalaxyl-M, furalaxyl, metalaxyl, metalaxyl-M or pefurazoate; anilide fungicides, such as benalaxyl, benalaxyl-M, boscalid, carboxin, fenhexamid, metalaxyl, metalaxyl-M, metsulfovax, ofurace, oxadixyl, oxycarboxin, pyracarbolid, thifluzamide or tiadinil; in particular benzanilide fungicides, such as benodanil, flutolanil, mebenil, mepronil, salicylanilide or tecloftalam; furanilide fungicides, such as fenfuram, furalaxyl, furcarbanil or methfuroxam; and sulfonanilide fungicides, such as flusulfamide; benzamide fungicides, such as benzohydroxamic acid, fluopicolide, tioxymid, trichlamide, zarilamid or zoxamide; furamide fungicides, such as cyclafuramid or furmecyclox; phenylsulfamide fungicides, such as dichiofluanid or tolylfluanid; sulfonamide fungicides, such as cyazofamid; and valinamide fungicides, such as benthiavalicarb or iprovalicarb; antibiotic fungicides, such as aureofungin, blasticidin-S, cycloheximide, griseofulvin, kasugamycin, natamycin, polyoxins, polyoxorim, streptomycin or validamycin; in particular strobilurin fungicides, such as azoxystrobin, dimoxystrobin, fluoxastrobin, kresoxim-methyl, metominostrobin, orysastrobin, picoxystrobin, pyraclostrobin or trifloxystrobin; aromatic fungicides, such as biphenyl, chlorodinitronaphthalene, chloroneb, chlorothalonil, cresol, dicloran, quintozene or tecnazene; benzimidazole fungicides, such as benomyl, carbendazim, chlorfenazole, cypendazole, debacarb, fuberidazole, mecarbinzid, rabenzazole or thiabendazole; benzimidazole precursor fungicides, such as furophanate, thiophanate or thiophanate-methyl; benzothiazole fungicides, such as bentaluron, chlobenthiazone or TCMTB; bridged diphenyl fungicides, such as bithionol, dichlorophen or diphenylamine; carbamate fungicides, such as benthiavalicarb, furophanate, iprovalicarb, propamocarb, thiophanate or thiophanate-methyl; in particular benzimidazolyl-carbamate fungicides, such as benomyl, carbendazim, cypendazole, debacarb or mecarbinzid; and carbanilate fungicides, such as diethofencarb; conazole fungicides; in particular imidazoles, such as climbazole, clotrimazole, imazalil, oxpoconazole, prochloraz or triflumizole; and triazoles, such as azaconazole, bromuconazole, cyproconazole, diclobutrazol, difenoconazole, diniconazole, diniconazole-M, epoxiconazole, etaconazole, fenbuconazole, fluquinconazole, flusilazole, flutriafol, furconazole, furconazol-cis, hexaconazole, imibenconazole, ipconazole, metconazole, myclobutanil, penconazole, propiconazole, prothioconazole, quinconazole, simeconazole, tebuconazole, tetraconazole, triadimefon, triadimenol, triticonazole, uniconazole or uniconazole-P; copper fungicides, such as Bordeaux mixture, Burgundy mixture, Cheshunt mixture, copper acetate, copper carbonate, copper hydroxide, copper naphthenate, copper oleate, copper oxychloride, copper sulfate, copper zinc chromate, copper oxide, mancopper, cufraneb, cuprobam or oxine-copper; dicarboximide fungicides, such as famoxadone or fluoroimide; in particular dichlorophenyl dicarboximide fungicides, such as chlozolinate, dichlozoline, iprodione, isovaledione, myclozolin, procymidone or vinclozolin; and phthalimide fungicides, such as captafol, captan, ditalimfos, folpet or thiochlorfenphim; dinitrophenol fungicides, such as binapacryl, dinobuton, dinocap, dinocap-4, dinocap-6, dinocton, dinopenton, dinosulfon, dinoterbon or DNOC; dithiocarbamate fungicides, such as azithiram, carbamorph, cufraneb, cuprobam, disulfuram, ferbam, metam, nabam, tecoram, thiram or ziram; in particular cyclodithiocarbamate fungicides, such as dazomet, etem or milneb; and polymeric dithiocarbamate fungicides, such as mancopper, mancozeb, maneb, metiram, polycarbamate, propineb or zineb; imidazole fungicides, such as cyazofamid, fenamidone, fenapanil, glyodin, iprodione, isovaledione, pefurazoate or triazoxide; inorganic fungicides, such as potassium azide, sodium azide or sulfur; morpholine fungicides, such as, e.g., aldimorph, benzamorf, carbamorph, dimethomorph, dodemorph, fenpropimorph, flumorph or tridemorph; organophosphorus fungicides, such as ampropylfos, ditalimfos, edifenphos, fosetyl, hexylthiofos, iprobenfos, phosdiphen, pyrazophos, toiclofos-methyl or triamiphos; organotin fungicides, such as decafentin, fentin or tributyltin oxide; oxathiin fungicides, such as carboxin or oxycarboxin; oxazole fungicides, such as chlozolinate, dichlozoline, drazoxolon, famoxadone, hymexazol, metazoxolon, myclozolin, oxadixyl or vinclozolin; polysulfide fungicides, such as barium polysulfide, potassium polysulfide or sodium polysulfide; pyrazole fungicides, such as furametpyr or penthiopyrad; pyridine fungicides, such as boscalid, buthiobate, dipyrithione, fluazinam, fluopicolide, pyridinitril, pyrifenox, pyroxychloror pyroxyfur; pyrimidine fungicides, such as bupirimate, cyprodinil, diflumetorim, dimethirimol, ethirimol, fenarimol, ferimzone, mepanipyrim, nuarimol, pyrimethanil or triarimol; pyrrole fungicides, such as fenpiclonil, fludioxonil or fluoroimide; quinoline fungicides, such as ethoxyquin, halacrinate, 8-hydroxyquinoline sulfate, quinacetol or quinoxyfen; quinone fungicides, such as benquinox, chloranil, dichlone or dithianone; quinoxaline fungicides, such as quinomethionate, chlorquinox or thioquinox; thiazole fungicides, such as ethaboxam, etridiazole, metsulfovax, octhilinone, thiabendazole, thiadifluor or thifluzamide; thiocarbamate fungicides, such as methasulfocarb or prothiocarb; thiophene fungicides, such as ethaboxam or silthiofam; triazine fungicides, such as anilazine; triazole fungicides, such as bitertanol, fluotrimazole or triazbutil; urea fungicides, such as bentaluron, pencycuron or quinazamid; or unclassified fungicides, such as acibenzolar, acypetacs, allyl alcohol, benzalkonium chloride, benzamacril, bethoxazin, carvone, DBCP, dehydroacetic acid, diclomezine, diethyl pyrocarbonate, fenaminosulf, fenitropan, fenpropidin, formaldehyde, furfural, hexachlorobutadiene, isoprothiolane, methyl isothiocyanate, metrafenone, nitrostyrene, nitrothal-isopropyl, OCH, phthalide, piperalin, probenazole, proquinazid, pyroquilon, sodium orthophenylphenoxide, spiroxamine, sultropen, thicyofen, tricyclazole or zinc naphthenate.

According to a particular embodiment of the invention, fungicides (e1) comprise:
Strobilurins, such as, for example, azoxystrobin, dimoxystrobin, enestroburin, fluoxastrobin, kresoxim-methyl, metominostrobin, picoxystrobin, pyraclostrobin, trifloxystrobin, orysastrobin, methyl (2-chloro-5-[1-(3-methylbenzyloxy-imino)ethyl]benzyl)carbamate, methyl (2-chloro-5-[1-(6-methylpyridin-2-ylmethoxyimino)ethyl]benzyl)carbamate or methyl 2-(ortho(2,5-dimethylphenyl-oxymethyl)phenyl)-3-methoxyacrylate;

### Carboxamides

Carboxanilides, such as, for example, benalaxyl, benodanil, boscalid, carboxin, mepronil, fenfuram, fenhexamide, flutolanil, furametpyr, metalaxyl, ofurace, oxadixyl, oxycarboxin, penthiopyrad, thifluzamide, tiadinil, N-(4′-bromobiphenyl-2-yl)-4-difluoromethyl-2-methylthiazole-5-carboxamide, N-(4′-(trifluoro-methyl)biphenyl-2-yl)-4-difluoromethyl-2-methylthiazole-5-carboxamide, N-(4′-chloro-3′-fluorobiphenyl-2-yl)-4-difluoromethyl-2-methylthiazole-5-carboxamide, N-(3′,4′-dichloro-4-fluorobiphenyl-2-yl)-3-difluoromethyl-1-methylpyrazole-4-carboxamide, N-(3′,4′-dichloro-5-fluorobiphenyl-2-yl)-3-difluoromethyl-1-methylpyrazole-4-carboxamide or N-(2-cyanophenyl)-3,4-dichloroisothiazole-5-carboxamide. Suitable carboxanilides are furthermore benalaxyl-M, bixafen, isotianil, kiralaxyl, tecloftalam, 2-amino-4-methylthiazole-5-carboxanilide, 2-chloro-N-(1,1,3-trimethylindan-4-yl)nicotinamide, N-(3′,4′-dichloro-5-fluorobiphenyl-2-yl)-3-difluoromethyl-1-methyl-1H-pyrazole-4-carboxamide, N-(3′,4′-dichloro-5-fluorobiphenyl-2-yl)-3-trifluoromethyl-1-methyl-1H-pyrazole-4-carboxamide, N-[2-(1,3-dimethylbutyl)phenyl]-5-fluoro-1,3-dimethyl-1H-pyrazole-4-carboxamide, N-(4′-chloro-3′,5-difluorobiphenyl-2-yl)-3-difluoromethyl-1-methyl-1H-pyrazole-4-carboxamide, N-(4′-chloro-3′,5-difluorobiphenyl-2-yl)-3-trifluoromethyl-1-methyl-1H-pyrazole-4-carboxamide, N-(3′,5-difluoro-4′-methylbiphenyl-2-yl)-3-difluoromethyl-1-methyl-1H-pyrazole-4-carboxamide, N-(3′,5-difluoro-4′-methylbiphenyl-2-yl)-3-trifluoromethyl-1-methyl-1H-pyrazole-4-carboxamide, N-[2-(bicyclopropyl-2-yl)phenyl]-3-difluoromethyl-1-methyl-1H-pyrazole-4-carboxamide, N-[2-(cis-bicyclopropyl-2-yl)phenyl]-3-difluoromethyl-1-methyl-1H-pyrazole-4-carboxamide and N-[2-(trans-bicyclopropyl-2-yl)phenyl]-3-difluoromethyl-1-methyl-1H-pyrazole-4-carboxamide;
carboxylic acid morpholides, such as, for example, dimethomorph or flumorph;
benzamides, such as, for example, flumetover, fluopicolide (picobenzamid) or zoxamide. Also suitable is N-(3-ethyl-3,5,5-trimethylcyclohexyl)-3-formylamino-2-hydroxybenzamide;
other carboxamides, such as, for example, carpropamid, diclocymet, mandipropamid, N-(2-(4-[3-(4-chlorophenyl)prop-2-ynyloxy]-3-methoxy-phenyl)ethyl)-2-methylsulfonylamino-3-methylbutyramide or N-(2-(4-[3-(4-chlorophenyl)prop-2-ynyloxy]-3-methoxyphenyl)ethyl)-2-ethylsulfonylamino-3-methylbutyramide. Furthermore suitable is oxytetracycline, silthiofam or N-(6-methoxypyridin-3-yl)cyclopropanecarboxamide;

### Azoles

triazoles, such as, for example, bitertanol, bromuconazole, cyproconazole, difenoconazole, diniconazole, enilconazole, epoxiconazole, fenbuconazole, flusilazole, fluquinconazole, flutriafol, hexaconazole, imibenconazole, ipconazole, metconazole, myclobutanil, penconazole, propiconazole, prothioconazole, simeconazole, tebuconazole, tetraconazole, triadimenol, triadimefon or triticonazole;
imidazoles, such as, for example, cyazofamid, imazalil, pefurazoate, prochloraz or triflumizole;
benzimidazoles, such as, for example, benomyl, carbendazim, fuberidazole or thiabendazole; and others, such as ethaboxam, etridiazole or hymexazole;

### Nitrogen-Comprising Heterocyclyl Compounds

pyridines, such as, for example, fluazinam, pyrifenox or 3-[5-(4-chlorophenyl)-2,3-dimethylisoxazolidin-3-yl]-pyridine;
pyrimidines, such as, for example, bupirimate, cyprodinil, ferimzone, fenarimol, mepanipyrim, nuarimol or pyrimethanil;
piperazines, such as triforine;
pyrroles, such as fludioxonil or fenpiclonil;
morpholines, such as aldimorph, dodemorph, fenpropimorph or tridemorph;
dicarboximides, such as iprodione, procymidone or vinclozolin;
others, such as acibenzolar-S-methyl, anilazine, captan, captafol, dazomet, diclomezine, fenoxanil, folpet, fenpropidin, famoxadone, fenamidone, octhilinone, probenazole, proquinazid, pyroquilon, quinoxyfen, tricyclazole or 6-aryl-[1,2,4]triazolo[1,5-a]pyrimidines, for example compounds of the formula (IV) defined below, e.g. 5-chloro-7-(4-methylpiperidin-1-yl)-6-(2,4,6-trifluorophenyl)-[1,2,4]triazolo[1,5-a]pyrimidine, 2-butoxy-6-iodo-3-propylchromen-4-one or N,N-dimethyl-3-(3-bromo-6-fluoro-2-methylindol-1-sulfonyl)-[1,2,4]triazole-1-sulfonamide;

### Carbamates and Dithiocarbamates

dithiocarbamates, such as ferbam, mancozeb, maneb, metiram, metam, propineb, thiram, zineb or ziram;
carbamates, such as diethofencarb, flubenthiavalicarb, iprovalicarb, propamocarb, methyl 3-(4-chlorophenyl)-3-(2-isopropoxycarbonylamino-3-methylbutyrylamino)propionate or 4-fluorophenyl N-(1-(1-(4-cyanophenyl)ethylsulfonyl)but-2-yl)carbamate;

### Other Fungicides

guanidines, such as dodine, iminoctadine or guazatine;
antibiotics, such as kasugamycin, polyoxins, streptomycin or validamycin A;
organometallic compounds, such as fentin salts;
sulfur-comprising heterocyclyl compounds, such as isoprothiolane or dithianon;
organophosphorus compounds, such as edifenphos, fosetyl, fosetyl-aluminum, iprobenfos, pyrazophos, tolclofos-methyl or phosphorous acid and its salts;
organochlorine compounds, such as thiophanate-methyl, chlorothalonil, dichlofluanid, tolylfluanid, flusulfamide, phthalide, hexachlorobenzene, pencycuron or quintozene;
nitrophenyl derivatives, such as binapacryl, dinocap or dinobuton;
others, such as, for example, spiroxamine, cyflufenamid, cymoxanil or metrafenon.

Herbicides (e2) comprise, for example, amide herbicides, such as allidochlor, beflubutamid, benzadox, benzipram, bromobutide, cafenstrole, CDEA, chlorthiamid, cyprazole, dimethenamid, dimethenamid-P, diphenamid, epronaz, etnipromid, fentrazamide, flupoxam, fomesafen, halosafen, isocarbamid, isoxaben, napropamide, naptalam, pethoxamid, propyzamide, quinonamid or tebutam; in particular anilide herbicides, such as chloranocryl, cisanilide, clomeprop, cypromid, diflufenican, etobenzanid, fenasulam, flufenacet, flufenican, mefenacet, mefluidide, metamifop, monalide, naproanilide, pentanochlor, picolinafen or propanil; in particular arylalanine herbicides, such as benzoylprop, flamprop or flamprop-M; chloroacetanilide herbicides, such as acetochlor, alachlor, butachlor, butenachlor, delachior, diethatyl, dimethachlor, metazachlor, metolachlor, S-metolachlor, pretilachlor, propachlor, propisochlor, prynachlor, terbuchlor, thenylchloror xylachlor; and sulfonanilide herbicides, such as benzofluor, cloransulam, diclosulam, florasulam, flumetsulam, metosulam, perfluidone, pyrimisulfan or profluazol; and sulfonamide herbicides, such as asulam, carbasulam, fenasulam, oryzalin or penoxsulam; antibiotic herbicides, such as bilanafos; aromatic acid herbicides; in particular benzoate herbicides, such as chloramben, dicamba, 2,3,6-TBA or tricamba; in particular pyrimidinyloxybenzoate herbicides, such as bispyribac or pyriminobac; and pyrimidinylthiobenzoate herbicides, such as pyrithiobac; phthalate herbicides, such as chlorthal; picolinate herbicides, such as aminopyralid, clopyralid or picloram; and quinolinecarboxylate herbicides, such as quinclorac or quinmerac; arsenical herbicides, such as cacodylat, CMA, DSMA, hexaflurate, MAA, MAMA, MSMA, potassium arsenite or sodium arsenite; benzoylcyclohexanedione herbicides, such as mesotrione or sulcotrione; benzofuranyl alkylsulfonate herbicides, such as benfuresate or ethofumesate; carbamate herbicides, such as asulam, carboxazole, chlorprocarb, dichlormate, fenasulam, karbutilate or terbucarb; carbanilate herbicides, such as barban, BCPC, carbasulam, carbetamide, CEPC, chlorbufam, chlorpropham, CPPC, desmedipham, phenisopham, phenmedipham, phenmedipham-ethyl, propham or swep; cyclohexene oxime herbicides, such as alloxydim, butroxydim, clethodim, cloproxydim, cycloxydim, profoxydim, sethoxydim, tepraloxydim or tralkoxydim; cyclopropylisoxazole herbicides, such as isoxachlortole or isoxaflutole; dicarboximide herbicides, such as benzfendizone, cinidon-ethyl, flumezin, flumiclorac, flumioxazin or flumipropyn; dinitroaniline herbicides, such as benfluralin, butralin, dinitramine, ethalfluralin, fluchloralin, isopropalin, methalpropalin, nitralin, oryzalin, pendimethalin, prodiamine, profluralin or trifluralin; dinitrophenol herbicides, such as dinofenate, dinoprop, dinosam, dinoseb, dinoterb, DNOC, etinofen or medinoterb; diphenyl ether herbicides, such as ethoxyfen; in particular nitrophenyl ether herbicides, such as acifluorfen, aclonifen, bifenox, chlomethoxyfen, chlornitrofen, etnipromid, fluorodifen, fluoroglycofen, fluoronitrofen, fomesafen, furyloxyfen, halosafen, lactofen, nitrofen, nitrofluorfen or oxyfluorfen; dithiocarbamate herbicides, such as dazomet or metam; halogenated aliphatic herbicides, such as alorac, chloropon, dalapon, flupropanate, hexachloroacetone, chloroacetic acid, SMA or TCA; imidazolinone herbicides, such as imazamethabenz, imazamox, imazapic, imazapyr, imazaquin or imazethapyr; inorganic herbicides, such as ammonium sulfamate, calcium chlorate, copper sulfate, iron sulfate, potassium azide, potassium cyanide, sodium azide, sodium chlorate or sulfuric acid; nitrile herbicides, such as bromobonil, bromoxynil, chloroxynil, dichlobenil, iodobonil, ioxynil or pyraclonil; organophosphorus herbicides, such as amiprofos-methyl, anilofos, bensulide, bilanafos, butamifos, 2,4-DEP, DMPA, EBEP, fosamine, glufosinate, glyphosate or piperophos; phenoxy herbicides, such as bromofenoxim, clomeprop, 2,4-DEB, 2,4-DEP, difenopenten, disul, erbon, etnipromid, fenteracol or trifopsime; in particular phenoxyacetic acid herbicides, such as 4-CPA, 2,4-D, 3,4-DA, MCPA or MCPA-thioethyl; phenoxybutyric acid herbicides, such as 4-CPB, 2,4-DB, 3,4-DB, MCPB or 2,4,5-TB; and phenoxypropionic acid herbicides, such as cloprop, 4-CPP, dichlorprop, dichlorprop-P, 3,4-DP, fenoprop, mecoprop or mecoprop-P; in particular aryloxyphenoxypropionic acid herbicides, such as chlorazifop, clodinafop, clofop, cyhalofop, diclofop, fenoxaprop, fenoxaprop-P, fenthiaprop, fluazifop, fluazifop-P, haloxyfop, haloxyfop-P, isoxapyrifop, metamifop, propaquizafop, quizalofop, quizalofop-P or trifop; phenylenediamine herbicides, such as dinitramine or prodiamine; phenyl pyrazolyl ketone herbicides, such as benzofenap, pyrazolynate, pyrazoxyfen or topramezone; pyrazolylphenyl herbicides, such as fluazolate or pyraflufen; pyridazine herbicides, such as credazine, pyridafol or pyridate; pyridazinone herbicides, such as brompyrazon, chloridazon, dimidazon, flufenpyr, metflurazon, norflurazon, oxapyrazon or pydanon; pyridine herbicides, such as aminopyralid, cliodinate, clopyralid, dithiopyr, fluoroxypyr, haloxydine, picloram, picolinafen, pyriclor, thiazopyr or triclopyr; pyrimidinediamine herbicides, such as iprymidam or tioclorim; quarternary ammonium herbicides, such as cyperquat, diethamquat, difenzoquat, diquat, morfamquat or paraquat; thiocarbamate herbicides, such as butylate, cycloate, di-allate, EPTC, esprocarb, ethiolate, isopolinate, methiobencarb, molinate, orbencarb, pebulate, prosulfocarb, pyributicarb, sulfallate, thiobencarb, tiocarbazil, tri-allate or vernolate; thiocarbonate herbicides, such as dimexano, EXD or proxane; thiourea herbicides, such as methiuron; triazine herbicides, such as dipropetryn, triaziflam or trihydroxy-triazine; in particular chlorotriazine herbicides, such as atrazine, chlorazine, cyanazine, cyprazine, eglinazine, ipazine, mesoprazine, procyazine, proglinazine, propazine, sebuthylazine, simazine, terbuthylazine or trietazine; methoxytriazine herbicides, such as atraton, methometon, prometon, secbumeton, simeton or terbumeton; and methylthiotriazine herbicides, such as ametryn, aziprotryne, cyanatryn, desmetryn, dimethametryn, methoprotryne, prometryn, simetryn or terbutryn; triazinone herbicides, such as ametridione, amibuzin, hexazinone, isomethiozin, metamitron or metribuzin; triazole herbicides, such as amitrole, cafenstrole, epronaz or flupoxam; triazolone herbicides, such as amicarbazone, carfentrazone, flucarbazone, propoxycarbazone or sulfentrazone; triazolopyrimidine herbicides, such as cloransulam, diclosulam, florasulam, flumetsulam, metosulam or penoxsulam; uracil herbicides, such as butafenacil, bromacil, flupropacil, isocil, lenacil or terbacil; urea herbicides, such as benzthiazuron, cumyluron, cycluron, dichloralurea, diflufenzopyr, isonoruron, isouron, methabenzthiazuron, monisouron or noruron; in particular phenylurea herbicides, such as anisuron, buturon, chlorbromuron, chloreturon, chlorotoluron, chloroxuron, daimuron, difenoxuron, dimefuron, diuron, fenuron, fluometuron, fluothiuron, isoproturon, linuron, methiuron, methyldymron, metobenzuron, metobromuron, metoxuron, monolinuron, monuron, neburon, parafluoron, phenobenzuron, siduron, tetrafluoron or thidiazuron; sulfonylurea herbicides; in particular pyrimidinylsulfonylurea herbicides, such as amidosulfuron, azimsulfuron, bensulfuron, chlorimuron, cyclosulfamuron, ethoxysulfuron, flazasulfuron, flucetosulfuron, flupyrsulfuron, foramsulfuron, halosulfuron, imazosulfuron, mesosulfuron, nicosulfuron, orthosulfamuron, oxasulfuron, primisulfuron, pyrazosulfuron, rimsulfuron, sulfometuron, sulfosulfuron or trifloxysulfuron; and triazinylsulfonylurea herbicides, such as chlorsulfuron, cinosulfuron, ethametsulfuron, iodosulfuron, metsulfuron, prosulfuron, thifensulfuron, triasulfuron, tribenuron, triflusulfuron or tritosulfuron; and thiadiazolylurea herbicides, such as buthiuron, ethidimuron, tebuthiuron, thiazafluoron or thidiazuron; and other herbicides, such as acrolein, allyl alcohol, azafenidin, benazolin, bentazone, benzobicyclon, buthidazole, calcium cyanamide, cambendichlor, chlorfenac, chlorfenprop, chlorflurazole, chlorflurenol, cinmethylin, clomazone, CPMF, cresol, ortho-dichlorobenzene, dimepiperate, endothal, fluoromidine, fluridone, fluorochloridone, flurtamone, fluthiacet, indanofan, methazole, methyl isothiocyanate, nipyraclofen, OCH, oxadiargyl, oxadiazon, oxaziclomefone, pentoxazone, pinoxaden, prosulfalin, pyribenzoxim, pyriftalid, quinoclamine, rhodethanil, sulglycapin, thidiazimin, tridiphane, trimeturon, tripropindan or tritac.

According to a particular embodiment of the invention, herbicides (e2) comprise:
1,3,4-thiadiazoles, such as buthidazole and cyprazole;
amides, such as allidochlor, benzoylprop-ethyl, bromobutide, chlorthiamid, dimepiperate, dimethenamid, diphenamid, etobenzanid, flamprop-methyl, fosamine, isoxaben, metazachlor, monalide, naptalam, pronamide or propanil;
aminophosphoric acids, such as bilanafos, buminafos, glufosinat-ammonium, glyphosate or sulfosate;
aminotriazoles, such as amitrol, anilides, such as anilofos or mefenacet;
anilides, such as anilofos or mefenacet;
aryloxyalkanoic acids, such as 2,4-D, 2,4-DB, clomeprop, dichlorprop, dichlorprop-P, fenoprop, fluoroxypyr, MCPA, MCPB, mecoprop, mecoprop-P, napropamide, naproanilide or triclopyr;
benzoic acids, such as chioramben or dicamba;
benzothiadiazinones, such as bentazon;
bleachers, such as clomazone, diflufenican, fluorochloridone, flupoxam, fluridone, pyrazolate or sulcotrione;
carbamates, such as carbetamide, chlorbufam, chlorpropham, desmedipham, phenmedipham or vernolate;
quinolinic acids, such as quinclorac or quinmerac;
dichloropropionic acids, such as dalapon;
dihydrobenzofurans, such as ethofumesate;
dihydrofuran-3-ones, such as flurtamone;
dinitroanilines, such as benefin, butralin, dinitramine, ethalfluralin, fluchloralin, isopropalin, nitralin, oryzalin, pendimethalin, prodiamine, profluralin or trifluralin;
dinitrophenols, such as bromofenoxim, dinoseb, dinoseb acetate, dinoterb,
DNOC or medinoterb-acetate;
diphenyl ethers, such as acifluorfen-sodium, aclonifen, bifenox, chlornitrofen, difenoxuron, ethoxyfen, fluorodifen, fluoroglycofen-ethyl, fomesafen, furyloxyfen, lactofen, nitrofen, nitrofluorfen or oxyfluorfen;
dipyridyls, such as cyperquat, difenzoquat metilsulfate, diquat or paraquat dichloride;
imidazoles, such as isocarbamide;
imidazolinones, such as imazamethapyr, imazapyr, imazaquin, imazamethabenz-methyl, imazethapyr, imazapic or imazamox;
oxadiazoles, such as methazole, oxadiargyl or oxadiazon;
oxiranes, such as tridiphane;
phenols, such as bromoxynil or ioxynil;
phenoxyphenoxypropionic acid esters, such as clodinafop, cyhalofop-butyl, diclofop-methyl, fenoxaprop-ethyl, fenoxaprop-P-ethyl, fenthiaprop-ethyl, fluazifop-butyl, fluazifop-P-butyl, haloxyfop-ethoxyethyl, haloxyfop-methyl, haloxyfop-P-methyl, isoxapyrifop, propaquizafop, quizalofop-ethyl, quizalofop-P-ethyl or quizalofop-tefuryl;
phenylacetic acids, such as chlorfenac;
phenylpropionic acids, such as chlorfenprop-methyl;
ppi-active compounds, such as benzofenap, flumiclorac-pentyl, flumioxazin, flumipropyn, flupropacil, pyrazoxyfen, sulfentrazone or thidiazimin;
pyrazoles, such as nipyraclofen;
pyridazines, such as chloridazon, maleic hydrazide, norfiurazon or pyridate;
pyridinecarboxylic acids, such as clopyralid, dithiopyr, picloram or thiazopyr;
pyrimidyl ethers, such as pyrithiobac, pyrithiobac-sodium, KIH-2023 or KIH-6127;
sulfonamides, such as flumetsulam or metosulam;
triazolecarboxamides, such as triazofenamide;
uracils, such as bromacil, lenacil or terbacil;
furthermore benazolin, benfuresate, bensulide, benzofluor, bentazon, butamifos, cafenstrole, chlorthal-dimethyl, cinmethylin, dichlobenil, endothall, fluorbentranil, mefluidide, perfluidone, piperophos, topramezone and prohexadione-calcium;
sulfonylureas, such as amidosulfuron, azimsulfuron, bensulfuron-methyl, chlorimuron-ethyl, chlorsulfuron, cinosulfuron, cyclosulfamuron, ethametsulfuron-methyl, flazasulfuron, halosulfuron-methyl, imazosulfuron, metsulfuron-methyl, nicosulfuron, primisulfuron, prosulfuron, pyrazosulfuron-ethyl, rimsulfuron, sulfometuron-methyl, thifensulfuron-methyl, triasulfuron, tribenuron-methyl, triflusulfuron-methyl or tritosulfuron;
plant protection agents of the cyclohexenone type, such as alloxydim, clethodim, cloproxydim, cycloxydim, sethoxydim and tralkoxydim. Very particularly preferred herbicidal active agents of the cyclohexanone type are tepraloxydim (cf. AGROW, No. 243, 11.3.95, page 21, cycloxydim) and 2-(1-[2-{4-chlorophenoxy}propyloxyimino]butyl)-3-hydroxy- and of the sulfonylurea type: N-(((4-methoxy-6-[trifluoromethyl]-1,3,5-triazin-2-yl)amino)carbonyl)-2-(trifluoromethyl)benzenesulfonamide.

Insecticides (e3) comprise, for example, antibiotic insecticides, such as allosamidin or thuringiensin; in particular macrocyclic lactone insecticides, such as spinosad; in particular avermectin insecticides, such as abamectin, doramectin, emamectin, eprinomectin, ivermectin or selamectin; and milbemycin insecticides, such as lepimectin, milbemectin, milbemycinoxime or moxidectin; arsenical insecticides, such as calcium arsenate, copper acetoarsenite, copper arsenate, lead arsenate, potassium arsenite or sodium arsenite; botanical insecticides, such as anabasine, azadirachtin, d-limonene, nicotine, pyrethrins, cinerin E, cinerin I, cinerin II, jasmolin I, jasmolin II, pyrethrin I, pyrethrin II, quassia, rotenone, ryania or sabadilla; carbamate insecticides, such as bendiocarb or carbaryl; in particular benzofuranyl methylcarbamate insecticides, such as benfuracarb, carbofuran, carbosulfan, decarbofuran or furathiocarb; dimethylcarbamate insecticides, such as dimetan, dimetilan, hyquincarb or pirimicarb; oxime carbamate insecticides, such as alanycarb, aldicarb, aldoxycarb, butocarboxim, butoxycarboxim, methomyl, nitrilacarb, oxamyl, tazimcarb, thiocarboxime, thiodicarb or thiofanox; and phenyl methylcarbamate insecticides, such as allyxycarb, aminocarb, bufencarb, butacarb, carbanolate, cloethocarb, dicresyl, dioxacarb, EMPC, ethiofencarb, fenethacarb, fenobucarb, isoprocarb, methiocarb, metolcarb, mexacarbate, promacyl, promecarb, propoxur, trimethacarb, XMC or xylylcarb; dinitrophenol insecticides, such as dinex, dinoprop, dinosam or DNOC; insect growth regulators; in particular chitin synthesis inhibitors, such as bistrifluoron, buprofezin, chlorfluazuron, cyromazine, diflubenzuron, flucycloxuron, flufenoxuron, hexaflumuron, lufenuron, novaluron, noviflumuron, penfluoron, teflubenzuron or triflumuron; juvenile hormone mimics, such as epofenonane, fenoxycarb, hydroprene, kinoprene, methoprene, pyriproxyfen or triprene; juvenile hormones, such as juvenile hormone I, II and III; molting hormone agonists, such as chromafenozide, halofenozide, methoxyfenozide, tebufenozide; molting hormones, such as α-ecdysone or ecdysterone; molting inhibitors, such as diofenolan; precocenes, such as precocene I, II and III; and unclassified insecticides, such as dicyclanil; nereistoxin analogs, such as bensultap, cartap, thiocyclam or thiosultap; nicotinoid insecticides, such as flonicamid; in particular nitroguanidine insecticides, such as clothianidin, dinotefuran, imidacloprid or thiamethoxam; nitromethylene insecticides, such as nitenpyram or nithiazine; and pyridylmethylamine insecticides, such as acetamiprid, imidacloprid, nitenpyram or thiacloprid; organochlorine insecticides, such as isobenzan, isodrin, kelevan or mirex; organophosphorus insecticides, in particular organophosphate insecticides, such as bromfenvinfos, chlorfenvinphos, crotoxyphos, dichlorvos, dicrotophos, dimethylvinphos, fospirate, heptenophos, methocrotophos, mevinphos, monocrotophos, naled, naftalofos, phosphamidon, propaphos, TEPP or tetrachlorvinphos; organothiophosphate insecticides, such as dioxabenzofos, fosmethilan or phenthoate; in particular aliphatic organothiophosphate insecticides, such as acethion, amiton, cadusafos, chlorethoxyfos, chlormephos, demephion, demephion-O, demephion-S, demeton, demeton-O, demeton-S, demeton-methyl, demeton-O-methyl, demeton-S-methyl, demeton-S-methylsulphon, disulfoton, ethion, ethoprophos, IPSP, isothioate, malathion, methacrifos, oxydemeton-methyl, oxydeprofos, oxydisulfoton, phorate, sulfotep, terbufos or thiometon; in particular aliphatic amide organothiophosphate insecticides, such as amidithion, cyanthoate, dimethoate, ethoate-methyl, formothion, mecarbam, omethoate, prothoate, sophamide or vamidothion; and oxime organothiophosphate insecticides, such as chlorphoxim, phoxim or phoxim-methyl; heterocyclic organothiophosphate insecticides, such as azamethiphos, coumaphos, coumithoate, dioxathion, endothion, menazon, morphothion, phosalone, pyraclofos, pyridaphenthion or quinothion; especially benzothiopyran organothiophosphate insecticides, such as dithicrofos or thicrofos; benzotriazine organothiophosphate insecticides, such as azinphos-ethyl or azinphos-methyl; isoindole organothiophosphate insecticides, such as dialifos or phosmet; isoxazole organothiophosphate insecticides, such as isoxathion or zolaprofos; pyrazolopyrimidine organothiophosphate insecticides, such as chlorprazophos or pyrazophos; pyridine organothiophosphate insecticides, such as chlorpyrifos or chlorpyrifos-methyl; pyrimidine organothiophosphate insecticides, such as butathiofos, diazinon, etrimfos, lirimfos, pirimiphos-ethyl, pirimiphos-methyl, primidophos, pyrimitate or tebupirimfos; quinoxaline organothiophosphate insecticides, such as quinalphos or quinalphos-methyl; thiadiazole organothiophosphate insecticides, such as athidathion, lythidathion, methidathion or prothidathion; and triazole organothiophosphate insecticides, such as isazofos or triazophos; and phenyl organothiophosphate insecticides, such as azothoate, bromophos, bromophos-ethyl, carbophenothion, chlorthiophos, cyanophos, cythioate, dicapthon, dichlofenthion, etaphos, famphur, fenchlorphos, fenitrothion, fensulfothion, fenthion, fenthion-ethyl, heterophos, jodfenphos, mesulfenfos, parathion, parathion-methyl, phenkapton, phosnichlor, profenofos, prothiofos, sulprofos, temephos, trichlormetaphos-3 or trifenofos; phosphonate insecticides, such as butonate or trichlorfon; phosphonothioate insecticides, such as mecarphon; in particular phenyl ethylphosphonothioate insecticides, such as fonofos or trichloronat; and phenyl phenylphosphonothioate insecticides, such as cyanofenphos, EPN or leptophos; phosphoramidate insecticides, such as crufomate, fenamiphos, fosthietan, mephosfolan, phosfolan or pirimetaphos; phosphoramidothioate insecticides, such as acephate, isocarbophos, isofenphos, methamidophos and propetamphos; and phosphorodiamide insecticides, such as dimefox, mazidox, mipafox or schradan; oxadiazine insecticides, such as indoxacarb; phthalimide insecticides, such as dialifos, phosmet or tetramethrin; pyrazole insecticides, such as acetoprole, ethiprole, fipronil, pyrafluprole, pyriprole, tebufenpyrad, tolfenpyrad or vaniliprole; pyrethroid insecticides; in particular pyrethroid ester insecticides, such as acrinathrin, allethrin, bioallethrin, barthrin, bifenthrin, bioethanomethrin, cyclethrin, cycloprothrin, cyfluthrin, beta-cyfluthrin, cyhalothrin, gamma-cyhalothrin, lambda-cyhalothrin, cypermethrin, alpha-cypermethrin, beta-cypermethrin, theta-cypermethrin, zeta-cypermethrin, cyphenothrin, deltamethrin, dimefluthrin, dimethrin, empenthrin, fenfluthrin, fenpirithrin, fenpropathrin, fenvalerate, esfenvalerate, flucythrinate, fluvalinate, tau-fluvalinate, furethrin, imiprothrin, metofluthrin, permethrin, biopermethrin, transpermethrin, phenothrin, prallethrin, profluthrin, pyresmethrin, resmethrin, bioresmethrin, cismethrin, tefluthrin, terallethrin, tetramethrin, tralomethrin or transfluthrin; and pyrethroid ether insecticides, such as etofenprox, flufenprox, halfenprox, protrifenbute or silafluofen; pyrimidinamine insecticides, such as flufenerim or pyrimidifen; pyrrole insecticides, such as chlorfenapyr; tetronic acid insecticides, such as spiromesifen; thiourea insecticides, such as diafenthiuron; urea insecticides, such as flucofuron or sulcofuron; or unclassified insecticides, such as closantel, crotamiton, EXD, fenazaflor, fenoxacrim, flubendiamide, hydramethylnon, isoprothiolane, malonoben, metaflumizone, metoxadiazone, nifluridide, pyridaben, pyridalyl, rafoxanide, triarathene or triazamate.

According to a particular embodiment of the present invention, insecticides (e3) comprise:
organo(thio)phosphates, such as acephate, azamethiphos, azinphos-ethyl, azinphos-methyl, cadusafos, chlorethoxyfos, chlorfenvinphos, chlormephos, chlorpyrifos, chlorpyrifos-methyl, coumaphos, cyanophos, demeton-S-methyl, diazinon, dichlorvos/DDVP, dicrotophos, dimethoate, dimethylvinphos, disulfoton, EPN, ethion, ethoprophos, famphur, fenamiphos, fenitrothion, fenthion, fosthiazate, heptenophos, isoxathion, malathion, mecarbam, methamidophos, methidathion, methyl-parathion, mevinphos, monocrotophos, naled, omethoate, oxydemeton-methyl, paraoxon, parathion, parathion-methyl, phenthoate, phorate, phosalone, phosmet, phosphamidon, phorate, phoxim, pirimiphos, pirimiphos-methyl, profenofos, propetamphos, prothiofos, pyraclofos, pyridaphenthion, quinalphos, sulfotep, sulprofos, tebupirimfos, temephos, terbufos, tetrachlorvinphos, thiometon, triazophos, trichlorfon or vamidothion;
carbamates, such as alanycarb, aldicarb, bendiocarb, benfuracarb, butocarboxim, butoxycarboxim, carbaryl, carbofuran, carbosulfan, ethiofencarb, fenobucarb, fenoxycarb, formetanate, furathiocarb, isoprocarb, methiocarb, methomyl, metolcarb, oxamyl, pirimicarb, propoxur, thiodicarb, thiofanox, triazamate, trimethacarb, XMC or xylylcarb;
pyrethroids, such as acrinathrin, allethrin, d-cis-trans-allethrin, d-trans-allethrin, bifenthrin, bioallethrin, bioallethrin S-cyclopentenyl, bioresmethrin, cycloprothrin, cyfluthrin, beta-cyfluthrin, cyhalothrin, lambda-cyhalothrin, gamma-cyhalothrin, cyphenothrin, cypermethrin, alpha-cypermethrin, beta-cypermethrin, theta-cypermethrin, zeta-cypermethrin, deltamethrin, empenthrin, esfenvalerate, etofenprox, fenpropathrin, fenvalerate, flucythrinate, flumethrin, tau-fluvalinate, halfenprox, imiprothrin, permethrin, phenothrin, prallethrin, profluthrin, pyrethrin I and II, resmethrin, RU 15525, silafluofen, tefluthrin, tetramethrin, tralomethrin, transfluthrin, dimefluthrin or ZXI 8901;
arthropod growth regulators: a) chitin synthesis inhibitors, e.g. benzoylureas, such as bistrifluoron, chlorfluazuron, diflubenzuron, flucycloxuron, flufenoxuron, hexaflumuron, lufenuron, novaluron, noviflumuron, teflubenzuron, triflumuron, buprofezin, diofenolan, hexythiazox, etoxazole or clofentezine; b) ecdysone antagonists, such as chromafenozide, halofenozide, methoxyfenozide, tebufenozide or azadirachtin; c) juvenile hormone mimics, such as pyriproxyfen, hydroprene, kinoprene, methoprene or fenoxycarb; d) lipid biosynthesis inhibitors, such as spirodiclofen, spiromesifen or spirotetramat;
nicotine receptor agonists/antagonists: acetamiprid, clothianidin, dinotefuran, imidacloprid, nitenpyram, thiacloprid, thiamethoxam, nicotine, bensultap, cartap hydrochloride, thiocyclam, thiosultap-sodium or the thiazole compound of the formula (□1)

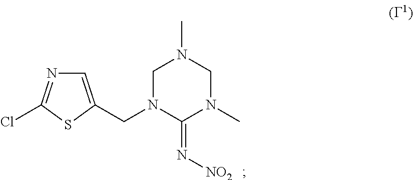

GABA antagonists, such as acetoprole, chlordane, endosulfan, ethiprole, gamma-HCH (lindane), fipronil, vaniliprole, pyrafluprole, pyriprole or phenylpyrazole compounds of the formula □2

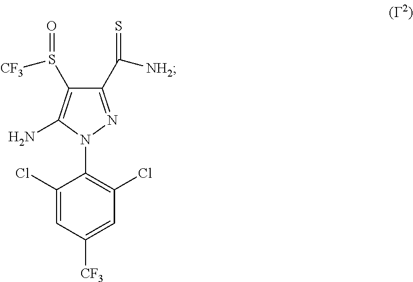

macrocyclic lactones, such as abamectin, emamectin, emamectin benzoate, milbemectin, lepimectin or spinosad;
METI I compounds, such as fenazaquin, fenpyroximate, flufenerim, pyridaben, pyrimidifen, rotenone, tebufenpyrad or tolfenpyrad;
METI II and III compounds, such as acequinocyl, fluacrypyrim or hydramethylnon;
uncoupling compounds, such as chlorfenapyr or DNOC;
inhibitors of oxidative phosphorylation, such as azocyclotin, cyhexatin, diafenthiuron, fenbutatin oxide, propargite or tetradifon;
various oxidase inhibitors, such as piperonyl butoxide;
sodium channel blockers, such as indoxacarb or metaflumizone;
microbial disruptors, such as Bacillus thuringiensis subsp. israelensis, Bacillus sphaericus, Bacillus thuringiensis subsp. aizawai, Bacillus thuringiensis subsp. kurstaki or Bacillus thuringiensis subsp. tenebrionis;
others, such as amitraz, benclothiaz, benzoximate, bifenazate, bromopropylate, cartap, chinomethionat, chloropicrin, flonicamid, methyl bromide, pyridalyl, pymetrozine, rynaxypyr, sulfur, potassium antimonyl tartrate, thiocyclam, tribufos, flubendiamide, cyenopyrafen, flupyrazofos, cyflumetofen, amidoflumet, NNI-0101, N—R′-2,2-dihalo-1-R″-cyclopropanecarboxamide 2-(2,6-dichloro [symbol] trifluoro-p-tolyphydrazone or N—R′-2,2-di(R″′)propionamide 2-(2,6-dichloro- [symbol] trifluoro-p-tolyphydrazone, in which R′ is methyl or ethyl, halo is chlorine or bromine, R″ is hydrogen or methyl and R″ is methyl or ethyl, anthranilamides of the formula □3

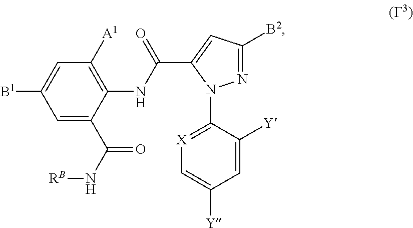

in which A1 is CH3, Cl, Br or I, X is C—H, C—Cl, C—F or N, Y′ is F, Cl or Br, Y″ is F, Cl or CF3, B1 is hydrogen, Cl, Br, I or CN, B2 is Cl, Br, CF3, OCH2CF3, OCF2H and RB is hydrogen, CH3 or CH(CH3)2, and malononitriles, such as described in JP 2002 284608, WO 02/89579, WO 02/90320, WO 02/90321, WO 04/06677, WO 04/20399 or JP 2004 99597;
malonodinitriles, such as CF3(CH2)2C(CN)2CH2(CF2)3CF2H, CF3(CH2)2C(CN)2CH2(CF2)5CF2H, CF3(CH2)2C(CN)2(CH2)2C(CF3)2F, CF3(CH2)2C(CN)2(CH2)2(CF2)3CF3, CF2H(CF2)3CH2C(CN)2CH2(CF2)3CF2H, CF3(CH2)2C(CN)2CH2(CF2)3CF3, CF3(CF2)2CH2C(CN)2CH2(CF2)3CF2H, CF3CF2CH2C(CN)2CH2(CF2)3CF2H, 2-(2,2,3,3,4,4,5,5-octafluoropentyl)-2-(3,3,4,4,4-pentafluorobutyl)malonodinitrile and CF2HCF2CF2CF2CH2C(CN)2CH2CH2CF2CF3;
fluorinated quinazolinones, such as:

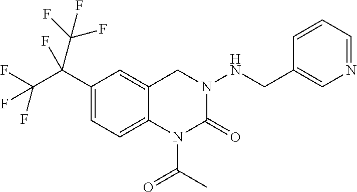

1-acetyl-3-[(pyridin-3-ylmethyl)amino]-6-(1,2,2,2-tetrafluoro-1-(trifluoromethyl)ethyl)-3,4-dihydro-1H-quinazolin-2-one;
in addition, pyrimidinyl alkynyl ethers of the formula Γ4 or thiadiazolyl alkynyl ethers of the formula Γ5:

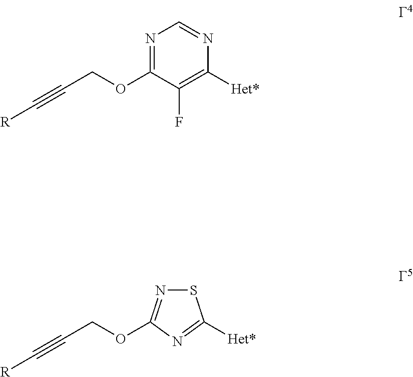

in which R is methyl or ethyl and Het* is 3,3-dimethylpyrrolidin-1-yl, 3-methylpiperidin-1-yl, 3,5-dimethylpiperidin-1-yl, 4-methylpiperidin-1-yl, hexahydroazepin-1-yl, 2,6-dimethylhexahydroazepin-1-yl or 2,6-dimethylmorpholin-4-yl. These compounds are described, for example, in JP 2006 131529.

Salts, in particular agriculturally useful salts, of the active agents especially mentioned here can also be used.

In a particular embodiment of the invention, the plant protection active agent is a fungicide.

In this connection, it is particularly preferable for the fungicide to be an active agent from the group consisting of the anilides, triazolopyrimidines, strobilurins and triazoles, in particular an anilide chosen from boscalid, carboxin, metalaxyl and oxadixyl, the triazolopyrimidine 5-chloro-7-(4-methylpiperidin-1-yl)-6-(2,4,6-trifluorophenyl)-[1,2,4]triazolo[1,5-a]pyrimidine, a strobilurin chosen from azoxystrobin, pyraclostrobin, dimoxystrobin, trifloxystrobin, fluoxastrobin, picoxystrobin and orysastrobin or a triazole chosen from epoxiconazole, metconazole, tebuconazole, flusilazole, fluquinconazole, triticonazole, propiconazole, penconazole, cyproconazole and prothioconazole.

The use of epoxiconazole is particularly preferred according to the invention.

The names of plant protection active agents, e.g. epoxiconazole, chosen here include isomeric forms of these compounds. Mention may be made in particular of stereoisomers, such as enantiomers or diastereomers, of the formulae. In addition to the essentially pure isomers, the compounds of the formulae also include their isomeric mixtures, e.g. stereoisomeric mixtures.

Preference is generally given to active agents with a higher proportion of the stereoisomer which, with regard to the optical antipode, is biologically more active, particularly preferably isomerically pure active agents.

The proportion of the active agent component (e) in the total weight of the composition generally comes to more than 1% by weight, preferably more than 2% by weight and in particular more than 2.5% by weight. On the other hand, the proportion of the component (e) in the total weight of the composition generally comes to less than 65% by weight, preferably less than 50% by weight and in particular less than 40% by weight, based on the total weight of the composition.

In this connection, the proportion of alcohol alkoxylate based on the amount of active agent, i.e. the ratio by weight of alcohol alkoxylate to plant protection active agent, is at least 0.5, preferably at least 1 and in particular at least 2.

According to a particular embodiment, the invention relates to suspension concentrates comprising:
(a) from 1 to 50% by weight, preferably from 5 to 50% by weight, e.g. approximately 25% by weight, of alcohol alkoxylate;
(b) from 0.5 to 50% by weight, preferably from 5 to 50% by weight, e.g. approximately 25% by weight, of cyclodextrin;
(c1) from 0.1 to 10% by weight, preferably from 1 to 10% by weight, e.g. approximately 5% by weight, of surface-active auxiliary;
(c2) from 0.1 to 10% by weight, preferably from 1 to 10% by weight, e.g. approximately 5% by weight, of antisettling agent;
(d) from 10 to 80% by weight, preferably from 5 to 50% by weight, e.g. approximately 27.5% by weight, of water; and
(e) from 1 to 65% by weight, preferably from 5 to 50% by weight, e.g. approximately 12.5% by weight, of plant protection active agent.

The suspension concentrates according to the invention can be prepared in a way known per se, for example according to a process which comprises the following process stages:
(i) the provision of a suspension comprising the essential ingredients of the suspension concentrate, and
(ii) the milling of the suspended solid particles down to the desired particle size.

The ingredients can be mixed with one another in conventional apparatuses suitable for this. A shear force sufficient to guarantee that a suspension is obtained should be applied to the mixture. The milling can also be carried out in a way knoWn per se. Preference is given to wet milling processes in appropriate apparatuses, bead mills in particular having proven to be particularly advantageous, for example the bead mill of the Drais Superflow DCP SF 12 type from Draiswerke Inc., 40 Whitney Road, Mahwah, N.J. 07430, USA; the circulation mill system Zeta from Netzsch-Feinmahltechnik GmbH, the disc mill from Netzsch Feinmahltechnik GmbH, Selb, Germany, the bead mill Eiger Mini 50 from Eiger Machinery Inc., 888 East Belvidere Rd., Grayslake, Ill. 60030, USA, and the bead mill Dyno-Mill KDL from WA Bachofen AG, Switzerland.

An additional subject matter of the present invention is accordingly the pesticidal, in particular fungicidal, insecticidal or herbicidal, treatment of plants and their habitats with a suspension concentrate according to the invention or the use of the disclosed suspension concentrates for the pesticidal, in particular fungicidal, insecticidal or herbicidal, treatment of plants and their habitats.

For this, the suspension concentrates according to the invention, before they are used, are generally converted by the user, e.g. the farmer or gardener, in a way essentially known, by dissolving, dispersing or emulsifying in water, to a ready-for-application application form, e.g. treated to give a spray mixture (tank mix method).

The spray mixture prepared can be applied in a generally known way in the spray method, especially by spraying, for instance, with a mobile spraying device from nozzles which distribute as finely as possible. The devices and working techniques furthermore conventional for this are known to a person skilled in the art.

According to a particular embodiment, the treatment of plants and their habitats is accordingly carried out in the spray method. In this connection, it is preferable for the preparation of the spray mixture to be applied to be carried out by dissolving, dispersing or emulsifying.

An additional subject matter of the present invention is a spray mixture comprising a suspension concentrate according to the invention for the pesticidal treatment of plants.

In a particular embodiment of the invention, the spray mixture comprises from 0.0001 to 10% by weight, preferably from 0.001 to 1% by weight and in particular from 0.01 to 0.5% by weight of plant protection active agent. This corresponds to approximately from 0.01 to 5% by weight, preferably from 0.05 to 3% by weight and in particular from 0.1 to 2% by weight of suspension concentrate according to the invention.

The suspension concentrates according to the invention show, because of the content of alcohol alkoxylate, a better effectiveness than comparable suspension concentrates without alcohol alkoxylate. No agglomeration of the active agent particles worth mentioning can be observed, even over relatively long time intervals. The suspension concentrates can easily be diluted with water, resulting in spray mixtures which are stable per se and can advantageously be applied.

The present invention will be more fully described using the following examples, which are not to be regarded as limiting.

### EXAMPLES 1 to 27

### Cyclodextrin-Comprising Compositions

A series of cyclodextrin-comprising suspension concentrates was prepared and evaluated as follows.

62.5 g of epoxiconazole were milled in the aqueous medium in an agitator bead mill (Dyno-Mill) together with each time 20 g/l of dispersant (Atlas G 5000 (Uniquema/Croda), Synperonic A (Uniquema/Croda)) and also 50 g/l of propylene glycol until a particle size of 80%<2 μm was achieved. 3 g/l of antifoaming agent, e.g. Rhodorsil 426 (Rhodia), 3 g/l of thickener, e.g. Thodopol 23 (Rhodia), and a biocide, e.g. Acticide MBS (Thor Chemie), were added to the mixture. 20, 40 or 80 g of alcohol alkoxylate (a C₉-C₁₁-alcohol+7 EO+1.5 BO) were stirred into this mixture until the formulation was homogeneous. The same or double the amount of cyclodextrin (Cavamax W 6 or W 7 or W 8; α-cyclodextrin, β-cyclodextrin or γ-cyclodextrin from Wacker Chemie AG, Germany) was now stirred into these mixtures and homogenized over 2 hours. Finally, the batches were made up to 1 liter with water.

The proportion by percent of the suspended active agent with a particle size of less than 2 μm was determined 24 hours or 10 days after the preparation of the suspension concentrates.

Furthermore, the surface tension of the suspension concentrates was determined according to the plate method using a (Krüss K100), by suspending 0.5 ml of each suspension concentrate in 1 I of distilled water (c=0.5%; surface tension of ethanol: 22.32 mN/m; surface tension of water: 70.90 mN/m).

TABLE 1

| | | | Particle | | |
|---|---|---|---|---|---|
| | Cyclodextrin | Alkoxylate | size <2 μm | | Surface tension |
| Ex. | (g/l) | (g/l) | 1 d | 10 d | (in mN/m) |
| 1 | — | 20 | 78.94 | 79.06 | 33.61 |
| 2 | 20/Cavamax W6 | 20 | 80.94 | 80.60 | 37.06 |
| 3 | 40/Cavamax W6 | 20 | 80.49 | 79.21 | 37.14 |
| 4 | — | 40 | 66.45 | 63.36 | 30.82 |
| 5 | 40/Cavamax W6 | 40 | 74.71 | 72.67 | 34.64 |
| 6 | 80/Cavamax W6 | 40 | 79.58 | 77.49 | 35.71 |
| 7 | — | 80 | 26.62 | 20.61 | 29.04 |
| 8 | 80/Cavamax W6 | 80 | 29.14 | 23.85 | 31.82 |
| 9 | 120/Cavamax W6 | 80 | 31.41 | 25.58 | 33.83 |
| 10 | — | 20 | 82.07 | 81.90 | 33.72 |
| 11 | 20/Cavamax W7 | 20 | 82.87 | 82.10 | 36.86 |
| 12 | 40/Cavamax W7 | 20 | 81.90 | 81.54 | 37.35 |
| 13 | — | 40 | 58.02 | 51.93 | 30.75 |
| 14 | 40/Cavamax W7 | 40 | 81.85 | 81.67 | 34.43 |
| 15 | 80/Cavamax W7 | 40 | 81.12 | 81.89 | 34.93 |
| 16 | — | 80 | 28.90 | 22.29 | 29.70 |
| 17 | 80/Cavamax W7 | 80 | 42.89 | 37.90 | 31.57 |
| 18 | 120/Cavamax W7 | 80 | 73.56 | 72.13 | 32.76 |
| 19 | — | 20 | 76.53 | 76.43 | 32.77 |
| 20 | 20/Cavamax W8 | 20 | 78.17 | 78.68 | 35.48 |
| 21 | 40/Cavamax W8 | 20 | 79.31 | 78.77 | 34.89 |
| 22 | — | 40 | 65.32 | 67.51 | 30.75 |
| 23 | 40/Cavamax W8 | 40 | 79.87 | 76.88 | 32.44 |
| 24 | 80/Cavamax W8 | 40 | 78.06 | 75.34 | 32.04 |
| 25 | — | 80 | 25.47 | 23.96 | 29.67 |
| 26 | 80/Cavamax W8 | 80 | 50.81 | 50.30 | 31.30 |
| 27 | 120/Cavamax W8 | 80 | 64.48 | 62.94 | 32.06 |

The results unambiguously verify that the addition of cyclodextrin to the suspension concentrates counteracts the agglomeration of active agent particles. Since the addition of cyclodextrin was associated with an increase in the surface tension, it may be assumed that the cyclodextrins selectively take up the surface-active alcohol alkoxylates from the aqueous phase and remove from the equilibrium.

The mechanism proposed is described simply to clarify the invention and does not limit it.

1-15. (canceled)

16. A suspension concentrate of a plant protection active agent, which concentrate comprises:
a) alcohol alkoxylate; and
b) cyclodextrin.

17. The suspension concentrate according to claim 16, wherein the alcohol alkoxylate is selected from the group consisting of alcohol alkoxylates of the formula
(I)
R¹—O—(CₘH₂ₘO)ₓ—(CₙH₂ₙO)_{y}—(CₚH₂ₚO)_{z}—R² (I)
in which
R¹ is an aliphatic hydrocarbon radical with from 1 to 100 carbon atoms;
R² is hydrogen, an organic radical or an inorganic acid group;
m, n and p are, independently of one another, a whole number from 2 to 16;
x, y and z are, independently of one another, a number from 0 to 1000; and
x+y+z corresponds to a value from 2 to 1000.

18. The suspension concentrate according to claim 16, the composition comprising from 1 to 50% by weight.

19. The suspension concentrate according to claim 16, wherein the cyclodextrin is a natural or modified cyclodextrin.

20. The suspension concentrate according to claim 19, wherein the natural cyclodextrin is chosen from α-cyclodextrin, β-cyclodextrin and γ-cyclodextrin.

21. The suspension concentrate according to claim 16, which comprises from 0.5 to 50% by weight.

22. The suspension concentrate according to claim 16, wherein the ratio by weight of cyclodextrin to alcohol alkoxylate is from 0.5:1 to 5:1.

23. The suspension concentrate according to claim 16, furthermore comprising additional auxiliary, wherein the additional auxiliary is chosen from
c1) surface-active auxiliaries;
c2) suspension agents, antifoaming agents, antifreeze agents and bactericides; and
c3) other auxiliaries for improving the handleability and/or physical properties of the formulation.

24. The suspension concentrate according to claim 23, which comprises at most 60% by weight of additional auxiliary.

25. The suspension concentrate according to claim 16, furthermore comprising:
d) a water-comprising fluid.

26. The suspension concentrate according to claim 16, which comprises from 1 to 65% by weight of plant protection active agent.

27. A method for preparing a solution, dispersion or emulsion (spray mixture) for the fungicidal, insecticidal or herbicidal treatment of plants and/or their habitat comprising dissolving, dispersing or emulsifying a suspension concentrate according to claim 16.

28. A method for the fungicidal, insecticidal or herbicidal treatment of plants and their habitat, which comprises dissolving, dispersing or emulsifying a suspension concentrate according to claim 16 and treating plants and/or their habitat with the resulting solution, dispersion or emulsion (spray mixture).

29. A spray mixture, which comprises a suspension concentrate according to claim 16.

30. A method of stabilizing a suspension concentrate which comprises alcohol alkoxylate, which method comprises adding a cyclodextrin to the suspension concentrate.

31. The suspension concentrate according to claim 18, the composition comprising from 5 to 40% by weight of alcohol alkoxylate.

32. The suspension concentrate according to claim 31, the composition comprising from 10 to 30% by weight of alcohol alkoxylate.

33. The suspension concentrate according to claim 21, which comprises from 5 to 45% by weight of cyclodextrin.

34. The suspension concentrate according to claim 33, which comprises from 10 to 40% by weight of cyclodextrin.

35. The suspension concentrate according to claim 17, wherein m, n and p are, independently of one another, 2, 3, 4 or 5.

36. The suspension concentrate according to claim 22, wherein the ratio by weight of cyclodextrin to alcohol alkoxylate is from 1:1 to 4:1.

37. The suspension concentrate according to claim 36, wherein the ratio by weight of cyclodextrin to alcohol alkoxylate is from 2:1 to 3:1.

38. The suspension concentrate according to claim 24, which comprises at most 55% by weight of additional auxiliary.

39. The suspension concentrate according to claim 38, which comprises at most 50% by weight of additional auxiliary.

40. The suspension concentrate according to claim 26, which comprises from 2 to 50% by weight of plant protection active agent.

41. The suspension concentrate according to claim 40, which comprises from 2.5 to 40% by weight of plant protection active agent.
